(19) United States
(12) Patent Application Publication
(10) Pub. No.: US 2025/0133456 A1
(43) Pub. Date: Apr. 24, 2025

(54) METHOD FOR CELL HANDOVER, AND DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jiangsheng FAN, Dongguan (CN)

(21) Appl. No.: 19/005,927

(22) Filed: Dec. 30, 2024

Related U.S. Application Data
(63) Continuation of application No. PCT/CN2022/110098, filed on Aug. 3, 2022.

(51) Int. Cl. H04W 36/00; H04L 5/00

(52) U.S. Cl. CPC H04W 36/00838; H04L 5/0044; H04W 36/0058

(57) ABSTRACT

Provided is a method for cell handover. The method for cell handover is applicable to a terminal. The method for cell handover includes: receiving first indication information; and performing a handover action based on the first indication information, wherein the handover action comprises switching a transmission configuration indication (TCI) state.

### CROSS-REFERENCE TO RELATED APPLICATION

This application is a continuation application of international application No. PCT/CN2022/110098, filed on Aug. 3, 2022, the entire contents of which are incorporated herein by reference.

### TECHNICAL FIELD

Embodiments of the present disclosure relate to the field of mobile communications, and in particular, relate to a method and apparatus for cell handover, and a device and a storage medium thereof.

### RELATED ART

In mobile communication systems, when a terminal moves from one cell to another cell, cell handover needs to be performed to maintain uninterrupted communication for the user of the terminal.

### SUMMARY

The present disclosure provides a method for cell handover, and a device. The technical solutions are as follows.

According to some embodiments of the present disclosure, a method for cell handover is provided. The method is applicable to a terminal. The method includes:
receiving first indication information; and
performing a handover action based on the first indication information, wherein the handover action includes switching a transmission configuration indication (TCI) state.

According to some embodiments of the present disclosure, a terminal is provided. The terminal includes: a processor; a transceiver, communicably connected to the processor; and a memory, configured to store one or more executable instructions, wherein the processor is configured to load and execute the one or more executable instructions, to cause the terminal to perform the method for cell handover.

According to some embodiments of the present disclosure, a network device is provided. The network device includes: a processor; a transceiver, communicably connected to the processor; and a memory, configured to store one or more executable instructions, wherein the processor is configured to load and execute the one or more executable instructions, to cause the network device to perform: transmitting first indication information, wherein the first indication information is used for instructing a terminal to perform a handover action, wherein the handover action includes switching a TCI state.

### BRIEF DESCRIPTION OF THE DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is an architectural diagram of the related art according to some exemplary embodiments of the present disclosure;

FIG. 2 is a scenario diagram of a method for cell handover according to some exemplary embodiments of the present disclosure;

FIG. 3 is a flowchart of a method for cell handover according to some exemplary embodiments of the present disclosure;

FIG. 4 is a schematic diagram of a method for cell handover according to some exemplary embodiments of the present disclosure;

FIG. 5 is a schematic diagram of a method for cell handover according to some exemplary embodiments of the present disclosure;

FIG. 6 is a schematic diagram of a method for cell handover according to some exemplary embodiments of the present disclosure;

FIG. 7 is a schematic diagram of a method for cell handover according to some exemplary embodiments of the present disclosure;

FIG. 8 is a schematic diagram of a method for cell handover according to some exemplary embodiments of the present disclosure;

FIG. 9 is a schematic diagram of a method for cell handover according to some exemplary embodiments of the present disclosure;

FIG. 10 is a schematic diagram of a method for cell handover according to some exemplary embodiments of the present disclosure;

FIG. 11 is a schematic diagram of a method for cell handover according to some exemplary embodiments of the present disclosure;

FIG. 12 is a schematic diagram of a method for cell handover according to some exemplary embodiments of the present disclosure;

FIG. 13 is a schematic diagram of a method for cell handover according to some exemplary embodiments of the present disclosure;

FIG. 14 is a schematic diagram of a method for cell handover according to some exemplary embodiments of the present disclosure;

FIG. 15 is a schematic diagram of a control plane protocol layer according to some exemplary embodiments of the present disclosure;

FIG. 16 is a flowchart of a method for cell handover according to some exemplary embodiments of the present disclosure;

FIG. 17 is a flowchart of a method for cell handover according to some exemplary embodiments of the present disclosure;

FIG. 18 is a flowchart of a method for cell handover according to some exemplary embodiments of the present disclosure;

FIG. 19 is a flowchart of a method for cell handover according to some exemplary embodiments of the present disclosure;

FIG. 20 is a flowchart of a method for cell handover according to some exemplary embodiments of the present disclosure;

FIG. 21 is a flowchart of a method for cell handover according to some exemplary embodiments of the present disclosure;

FIG. 22 is a flowchart of a method for cell handover according to some exemplary embodiments of the present disclosure;

FIG. 23 is a flowchart of a method for cell handover according to some exemplary embodiments of the present disclosure;

FIG. 24 is a flowchart of a method for cell handover according to some exemplary embodiments of the present disclosure;

FIG. 25 is a flowchart of a method for cell handover according to some exemplary embodiments of the present disclosure;

FIG. 26 is a flowchart of a method for cell handover according to some exemplary embodiments of the present disclosure;

FIG. 27 is a flowchart of a method for cell handover according to some exemplary embodiments of the present disclosure;

FIG. 28 is a structural block diagram of an apparatus for cell handover according to some exemplary embodiments of the present disclosure;

FIG. 29 is a structural block diagram of an apparatus for cell handover according to some exemplary embodiments of the present disclosure; and

FIG. 30 is a structural block diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

Exemplary embodiments of the present disclosure are described in detail herein, with examples illustrated in the accompanying drawings. When the following description refers to the accompanying drawings, the same numbers in different accompanying drawings represent the same or similar elements unless otherwise indicated. The exemplary embodiments described hereinafter do not represent all embodiments of present disclosure. Rather, these exemplary embodiments are merely examples of apparatus and methods according to some aspects of the present disclosure, as detailed in the appended claims.

The terms used in the present disclosure are for the purpose of describing specific embodiments only and are not intended to limit the present disclosure. As used in the present disclosure and the appended claims, the articles “a,” “an,” and “the” are intended to include the plural forms as well, unless the context clearly indicates otherwise. It should also be understood that the phrase “and/or” as used herein refers to and encompasses any or all possible combinations of one or more associated listed items.

It should be understood that although the terms “first,” “second,” and the like may be used herein to describe various information, such information should not be limited to these terms. These terms are only used to distinguish the same type of information from one another. For example, a first parameter may also be referred to as a second parameter, and similarly, a second parameter may also be referred to as a first parameter, without departing from the scope of the present disclosure. The word “in a case that” herein may be interpreted as “in the case that,” “in the case of,” “when,” “upon,” or “in response to determining,” depending on the context.

First, the related technical background involved in the embodiments of the present disclosure is described as follows.

### Cell Handover

Similar to the long term evolution (LTE) system, the new radio (NR) system supports the handover process for terminals (user equipment, UE) in a connected state. In the case that a user who is using network services moves from one cell to another cell, or due to reasons such as the adjustment of radio transmission traffic load, activation of operational maintenance, and equipment failure, in order to ensure communication continuity and service quality, the system needs to transfer the communication link of the user from the source cell to a new target cell, i.e., execute the handover process.

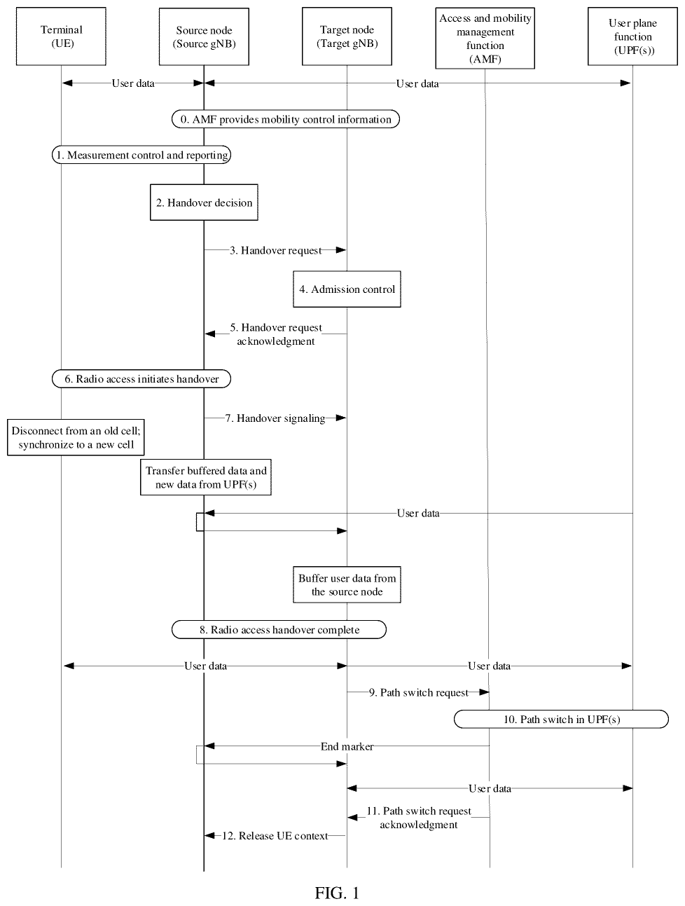

As shown in FIG. 1, taking an Xn interface handover process as an example, this handover process involves a terminal (UE), a source node (source gNB), a target node (target gNB), an access and mobility management function (AMF), and a user plane function (UPF). The handover process includes three phases.

1. Handover preparation phase: This phase includes steps 0 to 6 in FIG. 1, including measurement control, measurement result reporting, handover request, and handover acknowledgment. A handover acknowledgment message in step 5 includes a handover command generated by the target node. The source node is not allowed to modify the handover command in any way, but directly forwards the handover command to the UE.

2. Handover execution phase: This phase includes steps 7 to 8 in FIG. 1. After receiving the handover command in step 6, the UE immediately executes the handover process, disconnecting from the source cell and establishing a connection with the target cell.

3. Handover completion phase: This phase includes steps 9 to 12 in FIG. 1. The target node, along with the AMF and the UPF, executes path switch, and subsequently the UE context at the source node is released.

### Inter-Cell Beam Management (ICBM)

Beam management is to establish and maintain an appropriate beam pair, where the terminal selects an appropriate receive beam and the base station selects an appropriate transmit beam, to jointly maintain reliable communication connection. The terminal does not need to know what type of beam the network is using, but the NR standard also supports beam indication, which means that the network notifies the terminal that the same beam (or the same spatial filter) as the configured reference signal is used for a specific physical downlink shared channel (PDSCH) and/or physical downlink control channel (PDCCH) transmission. The reference signal may be a channel state information-reference signal (CSI-RS) or a synchronization signal and physical broadcast channel (PBCH) block (SSB).

Specifically, the beam indication is notified to the terminal over downlink medium-access control (MAC) signaling for radio resource control (RRC) configuration and transmission configuration indication (TCI). Each TCI state includes the information of a reference signal. By associating the TCI with a specific downlink transmission (PDCCH or PDSCH), the network notifies the terminal that the same spatial filter as the reference signal associated with the TCI is used for the downlink transmission.

In Rel-17, the beam management also uniformly introduces the beam management function for a non-serving cell within the TCI framework. The base station may configure an SSB of a non-serving cell as the quasi co-location (QCL) reference signal and the reference information for an uplink transmission spatial filter in a TCI state.

Based on this function, the terminal is capable of transmitting user-specific data with a transmission reception point (TRP) of the network of a non-serving cell without handover of the serving cell. To further reduce the delay and signaling overhead of a TCI state indication, a common TCI state indication for a plurality of component carriers (CC) used for carrier aggregation is also introduced to the unified TCI framework. In the function, a TCI state indication transmitted by the base station on a specific CC may indicate the TCI state for a plurality of CCs simultaneously, and these CCs may start using the newly indicated TCI state at the same time.

In the standardization progress of the 3rd Generation Partnership Project (3GPP), Rel-17 proposes redefinition of the TCI state, namely, a unified TCI state, which may represent an QCL relationship between different reference signals, and may be used for uplink and downlink beam indication in the beam management within the millimeter-wave frequency range (FR2).

In the NR standards of 3GPP Rel-15/Rel-16, the TCI state is only used for downlink beam indication, and signaling based on spatial relation information is used for uplink beam indication. Unlike previous TCI states, the unified TCI state unifies the beam indication mechanism for both uplink and downlink, that is, a downlink receive beam and an uplink transmit beam of the UE are symmetrical. The unified TCI state also unifies beams between different channels. That is, the same beam is used across different channels and signals of the UE.

For example, under the configuration of separate DL/UL TCI states, the UE considers that the PDCCH (UE-specific channel) and the PDSCH (UE-specific channel) are transmitted over the same beam. In addition, the UE transmits the PUCCH and the PUSCH over the same beam. Under the configuration of a joint TCI state for uplink and downlink, the UE considers that different channels and signals for uplink and downlink may have good beam symmetry, that is, a symmetric beam pair is used for uplink and downlink to conduct communication.

### Inter-Cell Multi-TRP Cooperative Transmission

In the multi-TRP cooperative transmission introduced in Rel-16, different TRPs belong to the same cell, that is, the PDCCH/PDSCH of different TRPs can only be directly or indirectly quasi-co-located (QCL) with the SSB of the serving cell. During multi-TRP cooperative transmission, it is necessary to separately indicate the QCL parameter information corresponding to each TRP. To extend the multi-TRP transmission scheme of Rel-16 to multi-cell cooperative scenarios, Rel-17 further enhances the multi-TRP transmission scheme based on multi-downlink control information (DCI), thereby supporting the inter-cell multi-TRP cooperative transmission scheme. Rel-17 introduces the following enhancements.

1. In the TCI state configured for the control resource set (CORESET) and PDSCH, the QCL reference source signal may be an SSB from a neighbor cell, that is, the cell identifier carried in the SSB is different from that of the serving cell. However, a common control channel (such as common search space types 0/1/1A/2) may still only be quasi-co-located with SSB of the serving cell, that is, system information cannot be received from a neighbor cell.

2. The network device may configure up to 7 sets of neighbor cell SSB information using RRC signaling. Each set of SSB information includes a period of SSB, transmit power, and an actual position of the transmitted SSB. The network device may also activate two sets of TCI states using MAC signaling. Each set of TCI states is associated with a CORESET group index, and one set of TCI states is associated with the serving cell SSB, while the other set of TCI states is associated with one of the sets of neighbor cell SSB information configured using RRC. That is, the QCL reference source signal in the set of TCI states is the SSB of a neighbor cell pre-configured using RRC. The quantity of neighbor cell SSB information the terminal can support needs to be reported to the network over the UE capability.

3. On a frequency domain sequence (orthogonal frequency-division multiplexing, OFDM) symbol where the neighbor cell SSB associated with the currently activated TCI state is located, the terminal cannot transmit any uplink signal, thereby avoiding conflicts between the uplink signal and the neighbor cell SSB that needs to be measured.

With such a signaling design, in addition to the serving cell SSB, the network device may dynamically activate a set of neighbor cell SSB information as the QCL source signal for PDCCH/PDSCH, thereby supporting multi-TRP cooperative transmission between two different cells.

In the related art, upon receiving the handover command, the UE interrupts the connection with the source cell, establishes a protocol stack with the target cell, and initiates a synchronization process with the target cell. The cell handover process is subject to a large handover delay. Therefore, how to reduce the handover delay is an urgent problem to be solved. To reduce handover delay, Rel-18 introduced L1/L2-based handover. In the case that the UE performs the handover, at least the packet data convergence protocol (PDCP) layer does not need to be re-established, thereby reducing the time for rebuilding the protocol stack of the target cell to some extent. Additionally, the handover command is changed from RRC signaling to L1/L2 signaling, thereby reducing the transmission delay of the handover command to some extent.

To further reduce handover delay and the terminal handover time caused by synchronization and protocol stack processing during handover, the present disclosure proposes a multi-TRP mechanism-based method for cell handover.

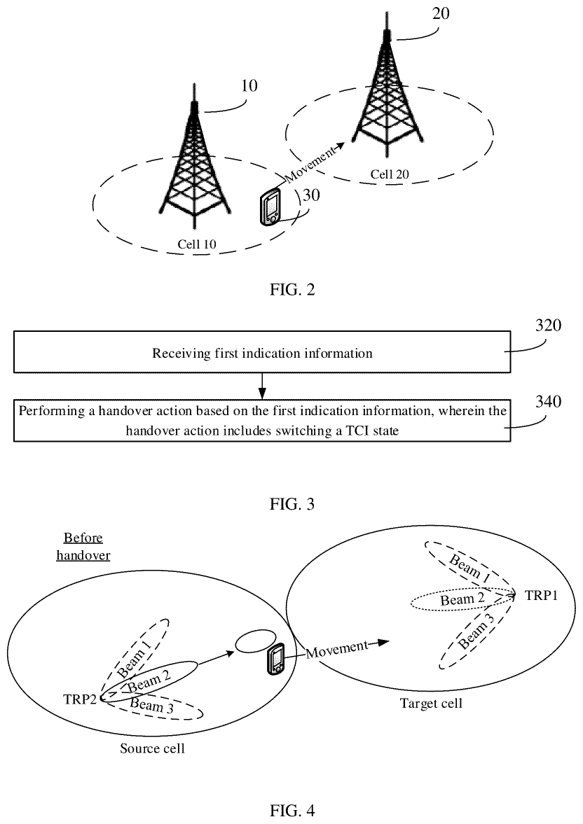

FIG. 2 is a scenario diagram of a method for cell handover according to some exemplary embodiments of the present disclosure. The scenario involves a cell 10, a cell 20, and a terminal 30.

The TRP corresponding to the cell 10 is TRP10 and the TRP corresponding to the cell 20 is TRP20. Assume that the source cell of the terminal 30 is the cell 10, and the target cell is the cell 20.

Exemplarily, the terminal 30 receives the first indication information from the TRP10 and performs a handover action based on the first indication information. The handover action includes at least switching the TCI state to achieve the handover from the cell 10 to the cell 20.

FIG. 3 is a flowchart of a method for cell handover according to some exemplary embodiments of the present disclosure. Description is given in the embodiments based on an example where the method is applicable to a terminal. The method includes the following processes.

In process 320, a terminal receives the first indication information.

The first indication information is the information used for instructing the terminal to perform cell handover. For example, the first indication information is cell handover signaling, a cell handover indication, a handover indication, a handover request response, and the like. The network transmits the first indication information to the terminal, and the terminal receives the first indication information.

In some embodiments, the first indication information is RRC signaling or L1/L2 signaling. To reduce handover delay, the first indication information may be L1/L2 signaling, and the first indication information is used for instructing the terminal to perform an L1/L2 handover.

In process 340, a handover action is performed based on the first indication information, wherein the handover action includes switching a TCI state.

The handover action refers to at least one action performed by the terminal during cell handover. In the embodiments, the handover action includes switching the TCI state. Switching the TCI state includes: switching at least one TCI state related to a source cell to at least one TCI state related to a target cell.

The TCI state is used for indicating the QCL parameters shared by the uplink transmission and/or downlink transmission of the terminal. One or more TCI states are present in the embodiments. In the case of performing multi-TRP cooperative transmission, the terminal indicates the QCL parameter information corresponding to the TRP using the TCI state.

Exemplarily, the TCI state is associated with a cell. The network configures at least one candidate cell for the terminal. Among the at least one candidate cell, the candidate cell to which the terminal will eventually hand over is referred to as the target cell.

In some embodiments, the TCI state is associated with the SSB or CSI-RS of the serving cell or non-serving cell, or associated with the sounding reference signal (SRS) of the serving cell.

In some embodiments, candidate cells performing multi-TRP cooperative transmission with the source/target cell among the at least one candidate cell are referred to as other candidate cells. The at least one TCI state related to the source cell refers to the TCI state associated with the source cell of the terminal, and the at least one TCI state related to the target cell refers to the TCI state associated with the target cell and/or other candidate cells of the terminal.

In some embodiments, the terminal independently selects and hands over to the target cell without receiving the first indication information. The independent target cell selection process is performed based on a pre-configured handover condition, a network-configured handover condition, a terminal-autonomous handover condition, or the like, without the network transmitting the first indication information to the terminal.

In summary, in the method according to the embodiments of the present disclosure, the terminal supports L1/L2 layer cell handover by switching the TCI state based on the received first indication information, which effectively reduces handover delay, such that the terminal handover time caused by synchronization and protocol stack processing during handover is reduced.

In some embodiments, switching the TCI state includes at least one of:
switching the TCI state of a common channel of the terminal; or
switching the TCI state of a dedicated channel of the terminal.

The dedicated channel (or proprietary channel) includes at least one of a PDCCH, a PDSCH, a PUCCH, or a PUSCH.

In the embodiments, by switching the TCI state of different types of channels of the terminal, targeted handover is achieved, and the efficiency of handover for different types of channels is improved.

Switching the TCI state for the common channel:

In some embodiments, switching the TCI state of the common channel of the terminal includes at least one of:
stopping receiving the common channel based on a first TCI state, wherein the first TCI state is associated with the source cell; or
receiving the common channel based on a second TCI state, wherein the second TCI state is associated with the target cell and/or other candidate cells.

Exemplarily, the TCI state is associated with a cell, and the TCI state of the common channel of the terminal includes a first TCI state and a second TCI state. The first TCI state refers to the TCI state associated with the source cell where the terminal is located, and the second TCI state refers to the TCI state associated with the target cell and/or other candidate cells.

The common channel is used for receiving a system broadcast message, a paging message, and the like. Exemplarily, the terminal stops receiving the common channel based on the first TCI state, i.e., stops receiving the system broadcast message, paging message, and the like, transmitted by the TRP of the source cell. The terminal receives the common channel based on the second TCI state, i.e., starts receiving the system broadcast message, paging message, and the like, from the TRP of the target cell and/or other candidate cells to establish a connection with the target cell and/or other candidate cells.

In some embodiments, the first TCI state is one TCI state in a TCI state configuration list of the source cell. The TCI state configuration list includes: a TCI state associated with the source cell (i.e., without explicitly indicating the physical cell identifier (PCI)) and/or a TCI state associated with an additional PCI (i.e., explicitly indicating the PCI). In the case that the terminal hands over from the source cell to the target cell, the terminal stores the PCI of the TCI state associated with the source cell or applies the configuration of the target cell upon completion of the handover.

In some embodiments, the first TCI state is also one TCI state in a common list, wherein each TCI state in the common list is associated with a PCI. The terminal may not release the common list in the case that the cell handover occurs within the range of candidate cells.

In some embodiments, the first TCI state is also one TCI state in the configuration of the target cell. After receiving the first indication information, the terminal determines the first TCI state based on the configuration of the target cell.

In some embodiments, the terminal communicates with the target cell or other candidate cells, that is, the terminal communicates with one TRP at the same time. It should be understood that in the case of communicating with other candidate cells, these other candidate cells may also be referred to as target cells. The terminal may also perform cooperative communication with the target cell and other candidate cells. In a cooperative transmission mode based on time-division multiplexing (TDM), the terminal performs transmission with at least two TRPs at different transmission occasions (TO) based on TDM, for example, performing transmission with TRP1 at the first transmission occasion and with TRP2 at the second transmission occasion. In the simultaneous transmission via multi-panel (STxMP) mode for multi-panel facing multi-TRP, the terminal communicates with at least two TRPs at the same time, which requires the terminal to have the capability to simultaneously receive and transmit at least two beams. In the STxMP scenario, the terminal may use transmission multiplexing modes such as space-division multiplexing (SDM), frequency-division multiplexing (FDM), or single frequency network (SFN).

In some embodiments, the terminal also performs cooperative communication with the source cell and the target cell. In the case of cooperative communication between the terminal and both the source cell and the target cell, the communication mode is the same as the cooperative communication mode between the terminal and the target cell and other candidate cells described in the above embodiments, which is not described herein any further.

In the embodiments, by switching the TCI state of the common channel of the terminal, a connection is established with the target cell and/or other candidate cells, thereby achieving cell handover.

Switching the TCI state for the dedicated channel of the terminal:

In some embodiments of the present disclosure, switching the TCI state of the dedicated channel of the terminal includes at least one of:
stopping receiving and/or transmitting the dedicated channel of the terminal based on a first TCI state, wherein the first TCI state is associated with the source cell;
continuing receiving and/or transmitting the dedicated channel of the terminal based on the first TCI state; or
receiving and/or transmitting the dedicated channel of the terminal based on a second TCI state, wherein the second TCI state is associated with the target cell and/or other candidate cells.

The dedicated channel of the terminal is used for the reception and/or transmission of the terminal-specific data. Exemplarily, the terminal stops receiving and/or transmitting the dedicated channel of the terminal based on the first TCI state, that is, stops data transmission with the TRP of the source cell and disconnects from the source cell. The terminal continues receiving and/or transmitting the dedicated channel of the terminal based on the first TCI state, that is, continues maintaining the connection with the source cell. The terminal receives and/or transmits the dedicated channel of the terminal based on the second TCI state, that is, starts data transmission with the TRP of the target cell and/or other candidate cells and establishes a connection with the new cell.

In some embodiments, after performing a handover to the target cell, the terminal only performs data transmission with the TRP of the target cell, or performs cooperative transmission with the TRPs of the target cell and other candidate cells, in which case data transmission with the TRP of the source cell is stopped, i.e., stopping receiving and/or transmitting the dedicated channel of the terminal based on the first TCI state.

In some embodiments, after performing a handover to the target cell, the terminal performs cooperative transmission with the TRPs of the target cell and the source cell, the terminal may continue data transmission with the TRP of the source cell, i.e., the terminal continues receiving and/or transmitting the dedicated channel of the terminal based on the first TCI state.

As an example, the situations before and after the terminal performs a cell handover include the following:

1. Communicating with one TRP prior to the cell handover and with one TRP upon the cell handover.

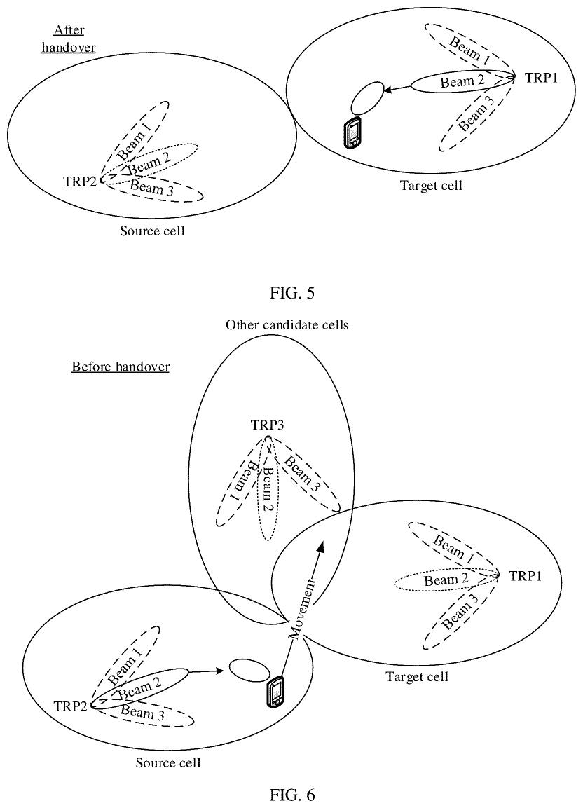

In one example, referring to FIG. 4, the terminal performs data transmission with TRP2 of the source cell prior to the cell handover. Referring to FIG. 5, the terminal performs data transmission with TRP1 of the target cell upon the cell handover. In this case, the first TCI state includes the TCI state associated with the source cell, and the second TCI state includes the TCI state associated with the target cell.

2. Communicating with one TRP before the cell handover and with at least two TRPs after the cell handover.

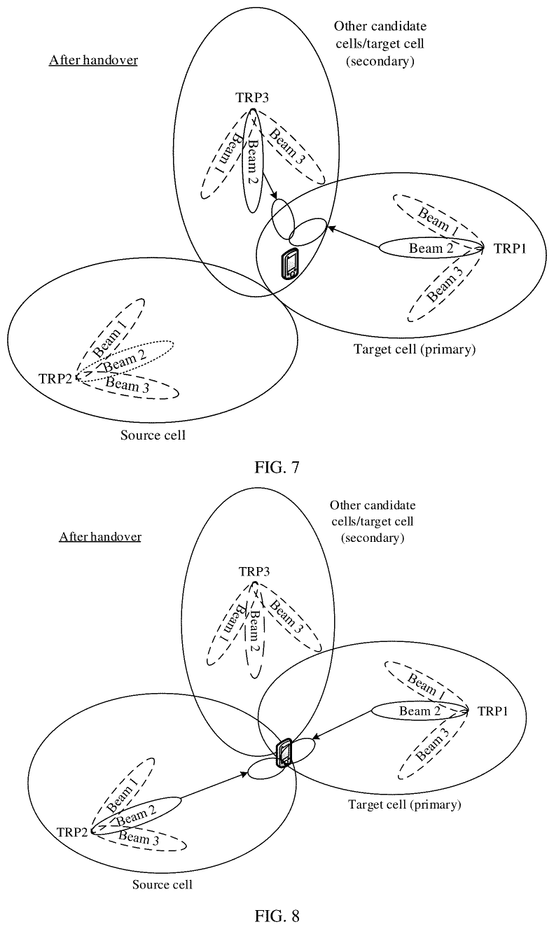

In one example, referring to FIG. 6, the terminal performs data transmission with TRP2 of the source cell before the cell handover. Referring to FIG. 7, the terminal communicates with at least two TRPs after the cell handover, which may be cooperative transmission with TRP1 of the target cell and TRP3 of other candidate cell. In some embodiments, other candidate cell is also referred to as target cell. The target cell where TRP1 is located is the primary target cell and the target cell where TRP3 is located is the secondary target cell, as shown in FIG. 7. In this case, the first TCI state includes the TCI state associated with the source cell, and the second TCI state includes the TCI state associated with the target cell and the TCI state associated with the other candidate cells.

In one example, referring to FIG. 6, the terminal performs data transmission with TRP2 of the source cell before the cell handover. Referring to FIG. 8, the terminal communicates with at least two TRPs after the cell handover, which may be cooperative transmission with TRP1 of the target cell and TRP2 of the source cell.

3. Communicating with at least two TRPs before the cell handover and with one TRP after the cell handover.

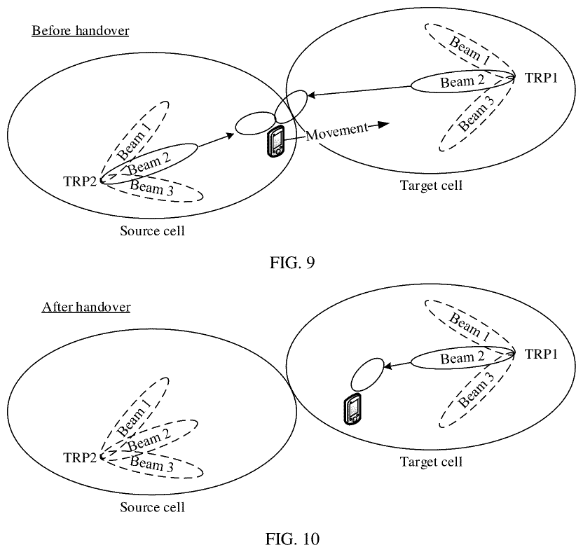

In one example, referring to FIG. 9, the terminal communicates with at least two TRPs before the cell handover, which may be data transmission with TRP2 of the source cell and TRP3 of another candidate cell; or data transmission with TRP2 of the source cell and TRP1 of the target cell. FIG. 9 takes the example of the terminal performing data transmission with TRP2 of the source cell and TRP1 of the target cell prior to the cell handover. Referring to FIG. 10, the terminal performs data transmission with TRP1 of the target cell upon the cell handover. In this case, the first TCI state includes the TCI state associated with the source cell and the TCI state associated with the target cell, and the second TCI state includes the TCI state associated with the target cell.

4. Communicating with at least two TRPs before the cell handover and with at least two TRPs after the cell handover.

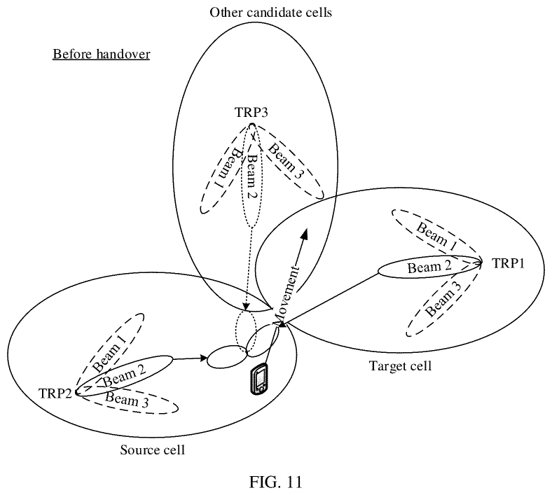

In one example, referring to FIG. 11, the terminal communicates with at least two TRPs before the cell handover, which may be data transmission with TRP2 of the source cell and TRP3 of other candidate cells; or data transmission with TRP2 of the source cell and TRP1 of the target cell. FIG. 11 takes the example of the terminal performing data transmission with TRP2 of the source cell and TRP1 of the target cell before the cell handover.

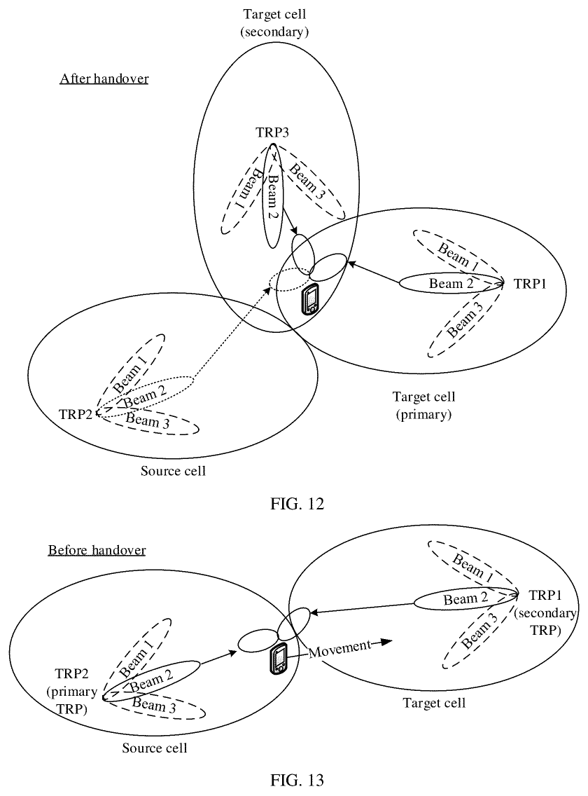

After the cell handover, the terminal communicates with at least two TRPs, which may be data transmission with TRP2 of the source cell and TRP1 of the target cell; or data transmission with TRP1 of the target cell and TRP3 of other candidate cell. FIG. 12 takes the example of the terminal performing data transmission with TRP1 of the target cell and TRP3 of the other candidate cell after the cell handover. The other candidate cell is also referred to as target cell. The target cell where TRP1 is located is the primary target cell, and the target cell where TRP3 is located is the secondary target cell. In this case, the first TCI state includes the TCI state associated with the source cell, and the second TCI state includes the TCI state associated with the target cell and the TCI state associated with the other candidate cells.

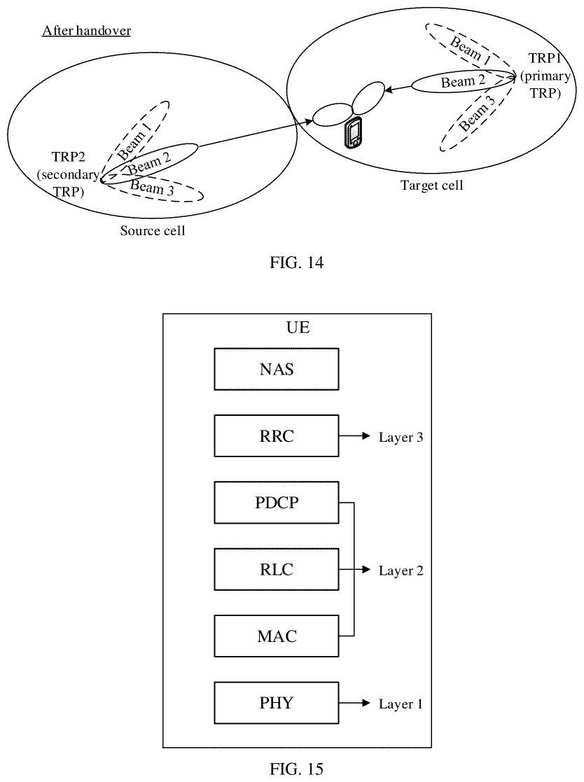

In another example, referring to FIG. 13, the terminal communicates with at least two TRPs before the cell handover, which may be data transmission with TRP2 of the source cell and TRP1 of the target cell. FIG. 14 illustrates the terminal communicating with at least two TRPs upon the cell handover, which may still be data transmission with TRP2 of the source cell and TRP1 of the target cell. However, it should be understood that upon the handover, the primary serving cell changes from the source cell to the target cell.

In the examples of FIGS. 13 and 14, the handover action further includes: switching the primary TRP and/or the secondary TRP.

Exemplarily, the terminal communicates with at least two TRPs before the cell handover and communicates with at least two TRPs after the cell handover, which is continuously communicating with the TRP of the source cell and the TRP of the target cell. Based on parameters such as transmission distance, transmission rate, or signal strength with each TRP, TRPs may be classified into primary TRP and secondary TRP. Upon the cell handover, the primary TRP and/or secondary TRP may be switched.

Switching the primary TRP and/or secondary TRP includes at least one of:
switching the TRP of the source cell from a primary TRP to a secondary TRP; or
switching the TRP of the target cell from a secondary TRP to a primary TRP.

Exemplarily, switching the primary TRP and/or secondary TRP may involve switching the TRP of the source cell from the primary TRP to the secondary TRP; and/or switching the TRP of the target cell from the secondary TRP to the primary TRP.

For example, in the examples of FIGS. 13 and 14, prior to the cell handover, the TRP of the source cell is the primary TRP, and the TRP of the target cell is the secondary TRP; after the cell handover, the TRP of the source cell is the secondary TRP, and the TRP of the target cell is the primary TRP.

In the embodiments, during the process of the terminal switching the primary TRP and/or secondary TRP, the terminal never disconnects from any TRP, such that communication between the terminal and a plurality of TRPs is achieved. By switching the TCI state of the dedicated channel of the terminal, the handover delay is reduced, and the communication between the terminal and one or more TRPs is achieved, which improves data transmission efficiency.

In one example, in addition to switching the TCI state, the handover action further includes: handing over the serving cell to the target cell and applying the configuration of the target cell. In some embodiments, applying the configuration of the target cell includes at least one of:
applying the TA of the target cell;
monitoring the downlink channel using the cell-radio network temporary identifier (C-RNTI) corresponding to the target cell;
initiating a random access procedure to the target cell; or
transmitting uplink data and/or uplink signaling to the target cell by using the uplink grant configured by the target cell.

In some embodiments, applying the timing advance (TA) of the target cell includes performing related configuration updates for TA, such as starting/restarting a TA timer. The TA timer is associated with the target cell or with a TA group (TAG).

In some embodiments, instead of monitoring the downlink channel by using the C-RNTI corresponding to the source cell, the downlink channel is monitored using the switched C-RNTI corresponding to the target cell.

In some embodiments, a random access procedure is initiated to the target cell.

In some embodiments, uplink data and/or uplink signaling are transmitted to the target cell using the uplink grant (UL grant) configured by the target cell. For example, the uplink data and/or uplink signaling are handover completion messages.

In some embodiments, the first indication information is L1/L2 signaling, for example, L1 signaling is DCI and L2 signaling is MAC CE, applying the configuration of the target cell includes any one or at least one of the following two methods.

Possible Method 1: After a PHY layer or a MAC layer receives the first indication information, layer 2 is instructed to apply the configuration of the target cell, and/or a layer 2 operation related to applying the configuration of the target cell is performed.

Possible Method 2: After a PHY layer or a MAC layer receives the first indication information, the information of the target cell is indicated to layer 3, to cause the layer 3 to instruct layer 2 to apply the configuration of the target cell, and/or performs a layer 2 operation related to applying the configuration of the target cell.

Layer 2 includes at least one of a PDCP layer, a radio-link control (RLC) layer, or a MAC layer, and layer 3 includes an RRC layer. The information of the target cell may be the identifier of the target cell and/or the configuration of the target cell.

As shown in FIG. 15, the control plane protocol layers of NR mainly include a physical (PHY) layer, a MAC layer, an RLC layer, a PDCP layer, an RRC layer, and a non-access stratum. Layer 1 (L1) is a PHY layer, layer 2 (L2) includes at least one of a PDCP layer, an RLC layer, or a MAC layer, and layer 3 (L3) includes an RRC layer.

In some embodiments, after the PHY layer or the MAC layer receives the first indication information, i.e., after receiving the L1/L2 handover command, at least one of a PDCP layer, an RLC layer, or a MAC layer is instructed to apply the configuration of the target cell, and/or related operations of at least one of a PDCP layer, an RLC layer, or a MAC layer related to applying the configuration of the target cell is performed.

In some embodiments, after the PHY or the MAC receives the first indication information, i.e., after receiving the L1/L2 handover command, the information of the target cell is indicated to the RRC layer, to cause the RRC layer to instruct at least one of a PDCP layer, an RLC layer, or a MAC layer to apply the configuration of the target cell, and/or related operations of at least one of the PDCP layer, the RLC layer, or the MAC layer related to applying the configuration of the target cell is performed.

In some embodiments of the present disclosure, the layer 2 operation includes at least one of: PDCP data recovery; PDCP re-establishment; RLC re-establishment; or MAC reset.

In some embodiments, the layer 2 operation includes at least one of PDCP data recovery, PDCP re-establishment, RLC re-establishment, or MAC reset.

It should be noted that in the two steps of instructing at least one of a PDCP layer, an RLC layer, or a MAC layer to apply the configuration of the target cell, and/or performing related operations of at least one of the PDCP layer, the RLC layer, or the MAC layer related to applying the configuration of the target cell, the specific protocol layers involved may be combined arbitrarily, which is not limited herein.

In the embodiments, applying the configuration of the target cell using various optional methods improves data processing efficiency.

In one example, the target cell indicated by the first indication information also includes at least one secondary cell, and/or the first indication information instructs the terminal to perform at least one of the actions of adding/activating/switching a secondary cell. The terminal adds/activates/switches the secondary cell based on the first indication information. The secondary cell is at least one of the candidate cells.

After the first indication information is received by the terminal, the first secondary cell list is updated. Exemplarily, the secondary cell configuration indicated by the first indication information is added/updated to the first secondary cell list.

Example 1 (determining to perform add/update operations based on the number of secondary cells in the first secondary cell list): The first secondary cell list includes n secondary cells. In the case that the first indication information indicates two secondary cells, the terminal updates the configurations of the secondary cells with the largest sequence numbers, from the (n−1)^{th} to the n^{th}, to the two secondary cells indicated by the first indication information. Alternatively, the terminal updates the configurations of the secondary cells with the smallest sequence numbers, from the 0^{th} to the 1^{st}, to the two secondary cells indicated by the first indication information. The terminal determines the indices of the replaced secondary cells based on the ascending or descending order of the candidate cell indices indicated in the first indication information. For example, a target cell with a larger index value is replaced by a secondary cell with a larger index value.

Alternatively, in the case that the secondary cell list is configured with n-m secondary cells (where n represents the maximum number of configurable secondary cells), and the first indication information indicates two secondary cells, the terminal adds the configurations of the two secondary cells to the first secondary cell list. The indices of the newly added two secondary cells are indicated by the first indication information.

Example 2 (determining to perform add/update operations based on the first indication information): The first secondary cell list includes n secondary cells. The first indication information instructs the terminal to replace two secondary cells in the first secondary cell list with two target cells. In some embodiments, the terminal updates the configurations of the secondary cells with the largest sequence numbers, from the (n−1)^{th} to the n^{th}, to the two secondary cells indicated by the first indication information, or updates the configurations of the secondary cells with the smallest sequence numbers, from the 0^{th} to the 1^{st}, to the two secondary cells indicated by the first indication information. The sequence number of the secondary cell is the secondary cell index. That is, the replacement rule is predefined or default. In some embodiments, the first indication information includes the index of the secondary cell that needs to be replaced. That is, the replacement rule is explicitly indicated by the network device.

Alternatively, in the case that the secondary cell list is configured with m secondary cells, and the first indication information instructs the terminal to add two secondary cells, the terminal adds the configurations of the two secondary cells to the first secondary cell list. The indices of the newly added two secondary cells are indicated by the first indication information.

In one example, the terminal also transmits the first secondary cell list update completion information to the network side. In some embodiments, the first secondary cell list update completion information is carried in a MAC CE or an RRC reconfiguration complete message to indicate that the UE has performed the corresponding operations based on the first indication information, such as completing the update of the first secondary cell list.

In one example, after receiving the first secondary cell indication information, the terminal considers that the at least one secondary cell is by default in an activated/deactivated state, or the first indication information indicates the state of the first secondary cell as activated/deactivated.

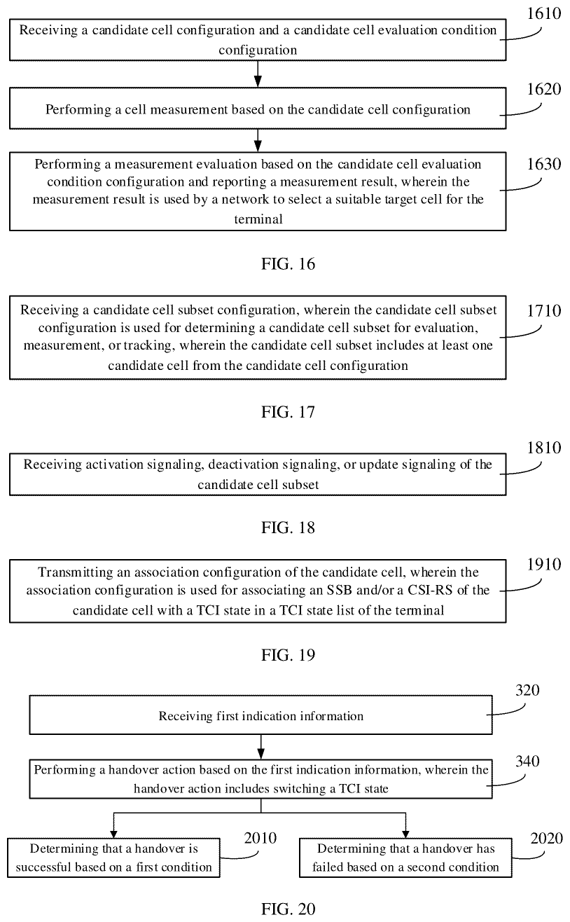

In one example, in a cell handover process, the terminal needs to measure and evaluate the configuration of a candidate cell and report the measurement result, such that the network determines the target cell based on the measurement result. FIG. 16 illustrates a flowchart of a method for cell handover according to some exemplary embodiments of the present disclosure. The method further includes the following processes.

In process 1610, the terminal receives a candidate cell configuration and a candidate cell evaluation condition configuration.

In process 1620, the terminal performs a cell measurement based on the candidate cell configuration.

In process 1630, the terminal performs a measurement evaluation based on the candidate cell evaluation condition configuration and reports a measurement result, wherein the measurement result is used by the network to select a suitable target cell for the terminal.

Exemplarily, the network configures at least one candidate cell for the terminal and transmits the candidate cell configuration and the candidate cell evaluation condition configuration to the terminal. The terminal receives the candidate cell configuration and the candidate cell evaluation condition configuration.

In some embodiments, the candidate cell evaluation condition configuration is an L3 measurement configuration and/or L1 measurement configuration.

In some embodiments, the candidate cell configuration includes at least one of:
a special cell configuration, which includes a primary cell configuration and a primary secondary cell configuration;
a secondary cell configuration, which includes a secondary cell configuration;
a cell group configuration, which includes a special cell configuration and a secondary cell configuration; or
a TRP configuration.

In some embodiments, the special cell configuration (SpCellConfig) includes a primary cell configuration (PCellConfig) and a primary secondary cell configuration (PSCellConfig).

In some embodiments, the candidate cell configuration includes a secondary cell configuration (SCellConfig).

In some embodiments, the cell group configuration (CellGroupConfig) includes the special cell configuration (SpCellConfig) and the secondary cell configuration (SCellConfig).

In some embodiments, each special cell configuration is associated with at least one candidate cell; and/or each cell group configuration is associated with at least one candidate cell.

At least one candidate cell uses at least one of a candidate cell identifier, a serving cell identifier (serving cell index), a physical cell identifier (PCI), or a cell global identifier (CGI).

As an example, the cell group configuration (CellGroupConfig) information element includes:

-- ASN1START
-- TAG-CELLGROUPCONFIG-START
-- Configuration of one Cell-Group:
CellGroupConfig ::= SEQUENCE {

| | |
|---|---|
| cellGroupId | CellGroupId, |
| rlc-BearerToAddModList | SEQUENCE (SIZE(1..maxLC-ID)) OF RLC- |
| BearerConfig | OPTIONAL, -- Need N |
| rlc-BearerToReleaseList | SEQUENCE (SIZE(1..maxLC-ID)) OF |
| LogicalChannelIdentity | OPTIONAL, -- Need N |
| mac-CellGroupConfig | MAC-CellGroupConfig |
| OPTIONAL, -- Need M | |
| physicalCellGroupConfig | PhysicalCellGroupConfig |
| OPTIONAL, -- Need M | |
| spCellConfig | SpCellConfig |
| OPTIONAL, -- Need M | |
| sCellToAddModList | SEQUENCE (SIZE (1..maxNrofSCells)) OF |
| SCellConfig | OPTIONAL, -- Need N |
| sCellToReleaseList | SEQUENCE (SIZE (1..maxNrofSCells)) OF |
| SCellIndex | OPTIONAL, -- Need N |
| ..., | |
| [[ | |
| reportUplinkTxDirectCurrent | ENUMERATED {true} |

OPTIONAL -- Cond BWP-Reconfig

| | |
|---|---|
| ]], | |
| [[ | |
| bap-Address-r16 | BIT STRING (SIZE (10)) |
| OPTIONAL, -- Need M | |
| bh-RLC-ChannelToAddModList-r16 | SEQUENCE (SIZE(1..maxBH-RLC- |
| ChannelID-r16)) OF BH-RLC-ChannelConfig-r16 | OPTIONAL, -- Need N |
| bh-RLC-ChannelToReleaseList-r16 | SEQUENCE (SIZE(1..maxBH-RLC- |
| ChannelID-r16)) OF BH-RLC-ChannelID-r16 | OPTIONAL, -- Need N |
| f1c-TransferPath-r16 | ENUMERATED {lte, nr, both} |
| OPTIONAL, -- Need M | |
| simultaneousTCI-UpdateList1-r16 | SEQUENCE (SIZE |
| (1..maxNrofServingCellsTCI-r16)) OF ServCellIndex | OPTIONAL, -- Need R |
| simultaneousTCI-UpdateList2-r16 | SEQUENCE (SIZE |
| (1..maxNrofServingCellsTCI-r16)) OF ServCellIndex | OPTIONAL, -- Need R |
| simultaneousSpatial-UpdatedList1-r16 | SEQUENCE (SIZE |
| (1..maxNrofServingCellsTCI-r16)) OF ServCellIndex | OPTIONAL, -- Need R |
| simultaneousSpatial-UpdatedList2-r16 | SEQUENCE (SIZE |
| (1..maxNrofServingCellsTCI-r16)) OF ServCellIndex | OPTIONAL, -- Need R |
| uplinkTxSwitchingOption-r16 | ENUMERATED {switchedUL, dualUL} |
| OPTIONAL, -- Need R | |
| uplinkTxSwitchingPowerBoosting-r16 | ENUMERATED {enabled} |
| OPTIONAL -- Need R | |
| ]], | |
| [[ | |
| reportUplinkTxDirectCurrentTwoCarrier-r16 | ENUMERATED {true} |
| OPTIONAL -- Need N | |
| ]] | |
| } | |

-- Serving cell specific MAC and PHY parameters for a SpCell:
SpCellConfig ::= SEQUENCE {

| | |
|---|---|
| servCellIndex | ServCellIndex |
| OPTIONAL, -- Cond SCG | |
| reconfiguration WithSync | Reconfiguration WithSync |
| OPTIONAL, -- Cond ReconfWithSync | |
| rlf-TimersAndConstants | SetupRelease { RLF-TimersAndConstants } |
| OPTIONAL, -- Need M | |
| rlmInSyncOutOfSyncThreshold | ENUMERATED {n1} |
| OPTIONAL, -- Need S | |
| spCellConfigDedicated | ServingCellConfig |
| OPTIONAL, -- Need M | |
| ... | |
| } | |
| Reconfiguration WithSync ::= | SEQUENCE { |
| spCellConfigCommon | ServingCellConfigCommon |
| OPTIONAL, -- Need M | |
| newUE-Identity | RNTI-Value, |
| t304 | ENUMERATED {ms50, ms100, ms150, |
| ms200, ms500, ms1000, ms2000, ms10000}, | |
| rach-ConfigDedicated | CHOICE { |
| uplink | RACH-ConfigDedicated, |
| supplementaryUplink | RACH-ConfigDedicated |
| } | |
| OPTIONAL, -- Need N | |
| ..., | |
| [[ | |
| smtc | SSB-MTC |
| OPTIONAL -- Need S | |
| ]], | |
| [[ | |
| daps-UplinkPowerConfig-r16 | DAPS-UplinkPowerConfig-r16 |
| OPTIONAL -- Need N | |
| ]] | |
| } | |
| DAPS-UplinkPowerConfig-r16 ::= | SEQUENCE { |
| p-DAPS-Source-r16 | P-Max, |
| p-DAPS-Target-r16 | P-Max, |
| uplinkPowerSharingDAPS-Mode-r16 | ENUMERATED {semi-static-mode1, |
| semi-static-mode2, dynamic } | |
| } | |

SCellConfig ::= SEQUENCE {

| | |
|---|---|
| sCellIndex | SCellIndex, |
| sCellConfigCommon | ServingCellConfigCommon |
| OPTIONAL, -- Cond SCellAdd | |
| sCellConfigDedicated | ServingCellConfig |
| OPTIONAL, -- Cond SCellAddSync | |
| ..., | |
| [[ | |
| smtc | SSB-MTC |
| OPTIONAL -- Need S | |
| ]], | |
| [[ | |
| sCellState-r16 | ENUMERATED {activated} |
| OPTIONAL, -- Cond SCellAddSync | |
| secondaryDRX-GroupConfig-r16 | ENUMERATED {true} |
| OPTIONAL -- Cond DRX-Config2 | |
| ]]} | |
| -- TAG-CELLGROUPCONFIG-STOP | |
| -- ASN1STOP | |

CellGroupConfig field represents the cell group configuration, and the main information elements include: cellGroupId (cell group identifier), rlc-BearerToAddModList (RLC bearer addition state list), rlc-BearerToReleaseList (RLC bearer release list), mac-CellGroupConfig (MAC layer cell group configuration), physicalCellGroupConfig (physical cell group configuration), spCellConfig (special cell configuration), sCellToAddModList (secondary cell addition state list), and sCellToReleaseList (secondary cell release list).

The spCellConfig field represents the special cell configuration, and the main information elements include: servCellIndex (serving cell index), reconfiguration WithSync (reconfiguration with synchronization), rlf-TimersAndConstants (timers and constants configuration), rlmInSyncOutOfSyncThreshold (radio link monitoring threshold configuration), spCellConfigDedicated (special cell dedicated information), spCellConfigCommon (special cell common information), newUE-Identity (new terminal identity), t304 (timer t304 configuration), and rach-ConfigDedicated (random access configuration).

The SCellConfig field represents the secondary cell configuration, and the main information elements include: sCellIndex (secondary cell index), sCellConfigCommon (secondary cell common information), sCellConfigDedicated (secondary cell dedicated information), smtc (SSB measurement timing configuration), sCellState-r16 (secondary cell state introduced in rel-16), and secondaryDRX-GroupConfig-r16 (information on whether the secondary cell introduced in rel-16 belongs to a secondary cell group).

In some embodiments, the TRP configuration includes at least one of:
a TCI state list;
a CSI configuration;
a measurement configuration;
a TAG configuration; or
a TRP validity configuration.

In some embodiments, the TRP configuration includes a TCI state list, and the TRP validity configuration is the activation/deactivation time information.

In some embodiments, the first indication information carries a target cell identifier indicating that the target cell is at least one of a primary cell, a secondary cell, or a cell within a cell group. Additionally or alternatively, the first indication information carries the TCI state information indicating the TCI state associated with the target cell.

In some embodiments, after receiving the first indication information and prior to performing the handover action by the terminal, the method further includes: determining whether the TCI state indicated in the first indication information is one of the TCI states in the TCI state list of the current serving cell (source cell). The one of the TCI states in the TCI state list refers to one of the TCI states activated by a MAC CE or one of the TCI states configured by RRC; or determining whether the target cell identifier in the first indication information is one of the non-serving cells associated with the TCI state of the current serving cell (source cell).

In some embodiments, the terminal receives the candidate cell configuration and the candidate cell evaluation condition configuration; the terminal performs the cell measurement based on the candidate cell configuration; the terminal performs the measurement evaluation based on the candidate cell evaluation condition configuration.

In some embodiments, the terminal reports the measurement result to the network, and the terminal performs the reporting based on autonomous triggering or network configuration. The measurement result is used by the network to select a suitable target cell for the terminal.

In the embodiments, the terminal performs the cell measurement and reports the measurement result based on the received information related to the candidate cell configuration, which is beneficial for the network to determine the target cell based on the measurement result.

For reduction of the overhead caused by the terminal in evaluating, measuring, and reporting the measurement result of a candidate cell, FIG. 17 illustrates a flowchart of a method for cell handover according to some exemplary embodiments of the present disclosure. The method further includes the following process.

In process 1710, the terminal receives a candidate cell subset configuration, wherein the candidate cell subset configuration is used for determining a candidate cell subset for evaluation, measurement, or tracking, and the candidate cell subset includes at least one candidate cell from the candidate cell configuration.

In some embodiments, the network configures a candidate cell subset, and one or more candidate cell subsets configurations are present. The candidate cell subset configuration is used for instructing the terminal to determine a candidate cell subset for evaluation, measurement, or tracking, and the candidate cell subset includes at least one candidate cell from the candidate cell configuration.

FIG. 18 illustrates a flowchart of a method for cell handover according to some exemplary embodiments of the present disclosure. The method further includes the following process.

In process 1810, the terminal receives activation signaling, deactivation signaling, or update signaling of the candidate cell subset.

In some embodiments, the activation signaling, deactivation signaling, or update signaling is RRC signaling or L1/L2 signaling. The network transmits the activation signaling, deactivation signaling, or update signaling of the candidate cell subset, that is, the terminal receives the activation signaling, deactivation signaling, or update signaling of the candidate cell subset.

In some embodiments, the candidate cell subset is associated with CSI-RS resource configuration or L1/L2 signaling. The determination and/or measurement of the candidate cell subset is based on L1 and/or L3 measurements.

In some embodiments, FIG. 19 illustrates a flowchart of a method for cell handover according to some exemplary embodiments of the present disclosure. The method further includes the following process.

In process 1910, the terminal receives an association configuration of the candidate cell, wherein the association configuration is used for associating the SSB and/or the CSI-RS of the candidate cell with the TCI state in the TCI state list of the terminal.

In some embodiments, in one example, the method further includes: receiving, by the terminal, activation signaling or deactivation signaling of the association configuration.

In some embodiments, the network activates/deactivates the association configuration using a medium access control (MAC) control element (CE). The process of transmitting the activation signaling or deactivation signaling is performed simultaneously when, before, or after the network transmits the candidate cell configuration, which is not limited herein and is determined by the network based on actual technical needs.

In some embodiments, in one example, the method further includes: receiving, by the terminal, a TA configuration of the candidate cell, wherein the TA configuration includes at least one of an adjustment value, an absolute value, or a TAG ID of the candidate cell.

Through the above embodiments, the overhead caused by the terminal in evaluating, measuring, and reporting the measurement result of a candidate cell can be effectively reduced.

In some embodiments of the present disclosure, the terminal also makes a decision on the handover result. FIG. 20 illustrates a flowchart of a method for cell handover according to some exemplary embodiments of the present disclosure. The method further includes the following process 2010 or process 2020.

In process 2010, the terminal determines that the handover is successful based on a first condition.

In process 2020, the terminal determines that the handover has failed based on a second condition.

### Regarding the First Condition:

In some embodiments, the first condition is the condition for determining a successful handover. The first condition includes at least one of the following items:
a random access is successful during the operation of a first timer;
a first downlink message is received without a random access procedure;
the first downlink message is successfully received based on the TCI state indicated by the first indication information; or
the measurement result of the downlink reference signal associated with the TCI state indicated by the first indication information is higher than a threshold.

In some embodiments, the first timer is T304, which is started when the PHY or the MAC receives the first indication information. The first timer is started by the RRC or by the PHY or MAC. In the case that the random access is successful during the operation of the first timer, the handover is determined to be successful, and the first timer is stopped in this case.

In some embodiments, the situation without a random access procedure (RACH-LESS) refers to cases where the network indicates the TA to the terminal in advance or in the first indication information, or the terminal estimates the TA by itself, or the terminal has performed the random access procedure in advance before receiving the first indication information.

In some embodiments, without random access, in the case that the terminal receives a first downlink message, the handover is determined to be successful. The first downlink message is DCI, MAC CE information, downlink data, or feedback of the first uplink message.

In some embodiments, the first downlink message includes:
a contention resolution MAC CE;
a TCI state indication;
a TCI state activation/deactivation message;
a new transmission or retransmission scheduled by PDCCH;
a TA command MAC CE;
a serving cell set based SRS TCI state indication MAC CE;
an SP/AP SRS TCI state indication MAC CE, wherein SP stands for service provider, and AP stands for application provider;
a BFD-RS indication MAC CE, wherein BFD-RS refers to a determined beam failure detection reference signal;
a unified TCI states activation/deactivation MAC CE; and
a PUCCH spatial relation activation/deactivation for multiple TRP PUCCH repetition MAC CE.

In some embodiments, the first downlink message is successfully received based on the TCI state indicated by the first indication information, and the first downlink message is any one of the first downlink messages mentioned above.

In some embodiments, the measurement result of the downlink reference signal associated with the TCI state indicated by the first indication information is higher than the threshold. The measurement result includes at least one of the measurement results of a reference signal received power (RSRP), a reference signal received quality (RSRQ), or a signal-to-interference-plus-noise ratio (SINR). RSRP refers to the power of the received reference signal, RSRQ refers to the quality of the received reference signal, and SINR refers to the ratio of the signal to interference plus noise.

Regarding the second condition:

In some embodiments, the second condition is the condition for determining a handover failure. The second condition includes at least one of the following items:
a random access has failed;
layer 1 indicates failure information;
a first timer has expired;
the maximum number of transmissions for a first uplink message has been reached; or
a new transmission schedule was not received prior to expiration of a second timer.

In some embodiments, in the case that the handover failure determination is performed at the RRC layer, the second condition includes at least one of the following items: a random access has failed; layer 1 indicates failure information; a first timer has expired; or the maximum number of transmissions for a first uplink message has been reached.

The failure information indicated by layer 1 is the information about a random access problem (RACH problem).

In some embodiments, in the case that the handover failure determination is performed at the MAC layer, the second condition includes at least one of the following items: a random access has failed; a first timer has expired; or a new transmission schedule was not received prior to expiration of a second timer.

The random access failure does not need to report the RACH problem to the RRC layer, the second timer is maintained and controlled by the MAC layer, and the reference to not receiving a new transmission schedule prior to expiration of a second timer pertains to situations without random access.

In some embodiments, in the case of a handover failure, the terminal performs at least one of:
indicating a handover failure or a random access problem to layer 2 or layer 3;
triggering an RRC connection re-establishment;
selecting a target cell that meets the reselection condition among candidate cells to trigger the handover again;
transmitting a handover failure indication to the source cell; or
releasing the candidate cell configuration.

In some embodiments, layer 2 and layer 3 refer to the upper layers of PHY/MAC.

In some embodiments, the reselection condition is to meet a preset threshold, meet a cell selection condition, or meet a cell reselection condition. Triggering a handover involves triggering an L1/L2 handover or a traditional RRC handover.

In some embodiments, in the case that the handover fails after the handover is triggered again, an RRC connection re-establishment is triggered.

In some embodiments, the handover failure indication is carried by at least one of an RRC message, a MAC CE, or a UCI. The UCI refers to a user class identifier.

In some embodiments, in the case that the handover failure indication is an RRC message or a MAC CE, the resource for transmitting the message is a dynamic grant (DG) resource and/or a configured grant (CG) resource.

In some embodiments, the handover failure indication includes: handover failure reason information and/or measurement result information of the handover-failed cell and/or the best beam identification information of the handover-failed cell. The measurement result information of the handover-failed cell includes a cell measurement result and/or a beam measurement result.

In the embodiments, the terminal may determine handover success or failure based on corresponding conditions and perform corresponding operations in the event of a handover failure, which improves the efficiency of handover execution and ensures the accuracy of the handover execution results.

As an example, the embodiments of the present disclosure further provide a corresponding relationship table between codepoints/indexes and logical channel identification (LCID) values, such that the terminal can quickly report parameter configuration information to the network or the network can quickly configure parameters for the terminal. The corresponding relationship table includes:

TABLE 1
Corresponding Relationship Table between
Codepoints/Indexes and LCID values

| Codepoint/Index | LCID values |
|---|---|
| 0 | A common control channel (CCCH) |
| 1-32 | Identity of the logical channel of a dedicated |
| | control channel (DCCH), a dedicated traffic channel |
| | (DTCH) and a multicast traffic channel (MTCH) |
| 33 | Extended logical channel ID field |
| | (two-octet eLCID field) |
| 34 | Extended logical channel ID field |
| | (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation |
| | for UE-specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 2
Corresponding Relationship Table between
Codepoints/Indexes and LCID values

| Codepoint | Index | LCID values |
|---|---|---|
| Oto226 | 64to290 | Reserved |
| 227 | 291 | Serving Cell Set based SRS TCI |
| | | State Indication MAC CE |
| 228 | 292 | SP/AP SRS TCI State Indication MAC CE |
| 229 | 293 | BFD-RS Indication MAC CE |
| 230 | 294 | Differential Koffset |
| 231 | 295 | Enhanced SCell Activation/Deactivation |
| | | MAC CE with one octet Cᵢ field |
| 232 | 296 | Enhanced SCell Activation/Deactivation |
| | | MAC CE with four octet Cᵢ field |
| 233 | 297 | Unified TCI States Activation/Deactivation |
| | | MAC CE |
| 234 | 298 | PUCCH Power Control Set Update for multiple |
| | | TRP PUCCH repetition MAC CE |
| 235 | 299 | PUCCH spatial relation Activation/Deactivation |
| | | for multiple TRP PUCCH repetition MAC CE |
| 236 | 300 | Enhanced TCI States Indication |
| | | for UE-specific PDCCH |
| 237 | 301 | Positioning Measurement Gap |
| | | Activation/Deactivation Command |
| 238 | 302 | PPW Activation/Deactivation Command |
| 239 | 303 | DL Tx Power Adjustment |
| 240 | 304 | Timing Case Indication |
| 241 | 305 | Child IAB-DU Restricted Beam Indication |
| 242 | 306 | Case-7 Timing advance offset |
| 243 | 307 | Provided Guard Symbols for Case-6 timing |
| 244 | 308 | Provided Guard Symbols for Case-7 timing |
| 245 | 309 | Serving Cell Set based SRS |
| | | Spatial Relation Indication |
| 246 | 310 | PUSCH Pathloss Reference RS Update |
| 247 | 311 | SRS Pathloss Reference RS Update |
| 248 | 312 | Enhanced SP/AP SRS Spatial Relation Indication |
| 249 | 313 | Enhanced PUCCH Spatial Relation |
| | | Activation/Deactivation |
| 250 | 314 | Enhanced TCI States Activation/Deactivation |
| | | for UE-specific PDSCH |
| 251 | 315 | Duplication RLC Activation/Deactivation |
| 252 | 316 | Absolute Timing Advance Command |
| 253 | 317 | SP Positioning SRS Activation/Deactivation |
| 254 | 318 | Provided Guard Symbols |
| 255 | 319 | Timing Delta |

In some embodiments, in addition to performing a handover action based on first indication information, the terminal also releases a first resource based on first indication information. In some embodiments, releasing the first resource based on the first indication information by the terminal includes at least one of:
notifying the RRC to release PUCCH resources for all serving cells in the case that a PUCCH resource is configured;
notifying the RRC to release SRS resources for all serving cells in the case that an SRS resource is configured;
clearing all configured downlink assignments and configured uplink grants; or
clearing all PUCCH resources for semi-persistent CSI reporting.

In some embodiments, the terminal, in the case of being configured with the PUCCH resource, notifies the RRC to release PUCCH resources for all serving cells; the terminal, in the case of being configured with the SRS resource, notifies the RRC to release SRS resources for all serving cells; the terminal clears any configured downlink assignments and configured uplink grants; the terminal clears any PUCCH resources for semi-persistent CSI reporting.

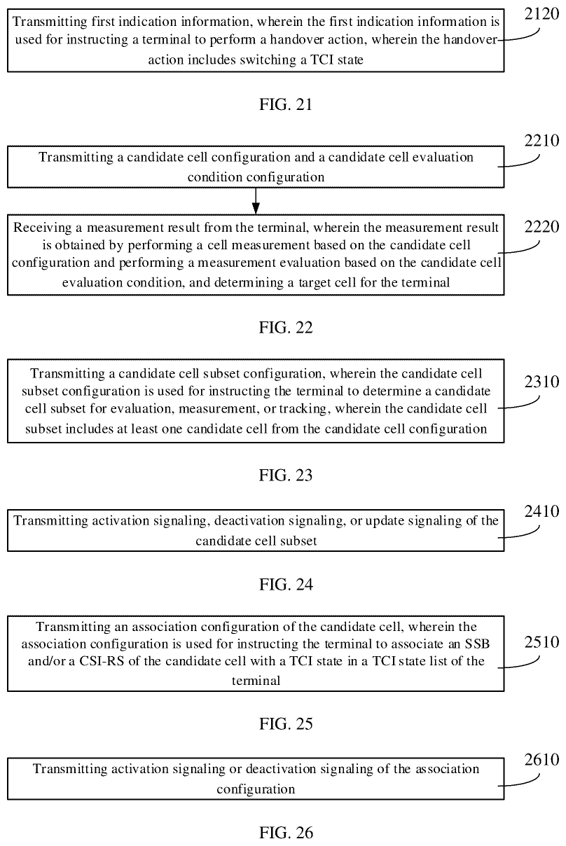

FIG. 21 illustrates a flowchart of a method for cell handover according to some exemplary embodiments of the present disclosure. Description is given in the embodiments based on an example where the method is applicable to a network device. The method includes the following process.

In process 2120, first indication information is transmitted, wherein the first indication information is used for instructing the terminal to perform a handover action, wherein the handover action includes switching a TCI state.

The first indication information is the information used for instructing the terminal to perform cell handover. For example, the first indication information is cell handover signaling, a cell handover indication, a handover indication, a handover request response, and the like. The network transmits the first indication information to the terminal, and the terminal receives the first indication information.

In some embodiments, the first indication information is RRC signaling or L1/L2 signaling. To reduce handover delay, the first indication information may be L1/L2 signaling, and the first indication information is for instructing the terminal to perform an L1/L2 handover.

In the embodiments, the handover action includes switching the TCI state. Switching the TCI state by the terminal includes: switching, by the terminal, at least one TCI state related to the source cell to at least one TCI state related to the target cell.

The TCI state is used for instructing the QCL parameters shared by the uplink transmission and/or downlink transmission of the terminal. One or more TCI states are present in the embodiments. In the case of performing multi-TRP cooperative transmission, the terminal indicates the QCL parameter information corresponding to the TRP over the TCI state.

Exemplarily, the TCI state is associated with a cell. The network configures at least one candidate cell for the terminal. Among the at least one candidate cell, the candidate cell to which the terminal will eventually hand over is referred to as the target cell.

In some embodiments, candidate cells performing multi-TRP cooperative transmission with the source/target cell among the at least one candidate cell are referred to as other candidate cells. The at least one TCI state related to the source cell refers to the TCI state associated with the source cell of the terminal, and the at least one TCI state related to the target cell refers to the TCI state associated with the target cell and/or other candidate cells of the terminal.

In some embodiments, the terminal independently selects and hands over to the target cell without receiving the first indication information. The independent target cell selection process is performed based on a pre-configured handover condition, a network-configured handover condition, a terminal-autonomous handover condition, or the like. In such cases, the network does not need to transmit the first indication information to the terminal.

In summary, in the method according to the embodiments of the present disclosure, the network transmits the first indication information to the terminal, and the terminal supports L1/L2 layer cell handover by switching the TCI state based on the received first indication information. In this way, handover delay is effectively reduced, such that the terminal handover time caused by synchronization and protocol stack processing during handover is reduced.

In some embodiments, switching the TCI state includes at least one of:
switching the TCI state of a common channel of the terminal; or
switching the TCI state of a dedicated channel of the terminal.

The dedicated channel (or proprietary channel) includes at least one of a PDCCH, a PDSCH, a PUCCH, or a PUSCH.

In the embodiments, by switching the TCI state of different types of channels of the terminal, targeted handover is achieved, and the efficiency of handover for different types of channels is improved.

Switching the TCI state for the common channel:

In some embodiments, the terminal switching the TCI state of the common channel of the terminal includes at least one of:
stopping receiving the common channel based on a first TCI state, wherein the first TCI state is associated with the source cell; or
receiving the common channel based on a second TCI state, wherein the second TCI state is associated with the target cell and/or other candidate cells.

Exemplarily, the TCI state is associated with a cell, and the TCI state of the common channel of the terminal includes the first TCI state and the second TCI state. The first TCI state refers to the TCI state associated with the source cell where the terminal is located, and the second TCI state refers to the TCI state associated with the target cell and/or other candidate cells.

The common channel is used for receiving a system broadcast message, a paging message, and the like. Exemplarily, the terminal stops receiving the common channel based on the first TCI state, i.e., stops receiving the system broadcast message, paging message, and the like, transmitted by the TRP of the source cell. The terminal receives the common channel based on the second TCI state, i.e., starts receiving the system broadcast message, paging message, and the like, from the TRP of the target cell and/or other candidate cells to establish a connection with the target cell and/or other candidate cells.

In some embodiments, the terminal communicates with the target cell or other candidate cells, that is, the terminal communicates with one TRP at the same time. It should be understood that in the case of communicating with other candidate cells, these other candidate cells may also be referred to as target cells. The terminal may also perform cooperative communication with the target cell and other candidate cells. In a cooperative transmission mode based on TDM, the terminal performs transmission with at least two TRPs at different TO based on TDM, for example, performing transmission with TRP1 at the first transmission occasion and with TRP2 at the second transmission occasion. In the STxMP mode for multi-panel facing multi-TRP, the terminal communicates with at least two TRPs at the same time, which requires the terminal to have the capability to simultaneously receive and transmit at least two beams. In the STxMP scenario, the terminal may use transmission multiplexing modes such as SDM, FDM, or SFN.

In some embodiments, the terminal also performs cooperative communication with the source cell and the target cell. In the case of cooperative communication between the terminal and both the source cell and the target cell, the communication mode is the same as the cooperative communication mode between the terminal and the target cell and other candidate cells described in the above embodiments, which is not described herein any further.

In the embodiments, by switching the TCI state of the common channel of the terminal, a connection is established with the target cell and/or other candidate cells, thereby achieving cell handover.

Switching the TCI state for the dedicated channel of the terminal:

In some embodiments of the present disclosure, the terminal switching the TCI state of the dedicated channel of the terminal includes at least one of:
stopping receiving and/or transmitting the dedicated channel of the terminal based on a first TCI state, wherein the first TCI state is associated with the source cell;
continuing receiving and/or transmitting the dedicated channel of the terminal based on the first TCI state; or
receiving and/or transmitting the dedicated channel of the terminal based on a second TCI state, wherein the second TCI state is associated with the target cell and/or other candidate cells.

The dedicated channel of the terminal is used for the reception and/or transmission of the terminal-specific data. Exemplarily, the terminal stops receiving and/or transmitting the dedicated channel of the terminal based on the first TCI state, that is, stops data transmission with the TRP of the source cell and disconnects from the source cell. The terminal continues receiving and/or transmitting the dedicated channel of the terminal based on the first TCI state, that is, continues maintaining the connection with the source cell. The terminal receives and/or transmits the dedicated channel of the terminal based on the second TCI state, that is, starts data transmission with the TRP of the target cell and/or other candidate cells and establishes a connection with the new cell.

In some embodiments, after performing a handover to the target cell, the terminal only performs data transmission with the TRP of the target cell, or performs cooperative transmission with the TRPs of the target cell and other candidate cells, in which case data transmission with the TRP of the source cell is stopped, i.e., stopping receiving and/or transmitting the dedicated channel of the terminal based on the first TCI state.

In some embodiments, after performing a handover to the target cell, the terminal performs cooperative transmission with the TRPs of the target cell and the source cell, the terminal may continue data transmission with the TRP of the source cell, i.e., the terminal continues receiving and/or transmitting the dedicated channel of the terminal based on the first TCI state.

In some embodiments, the handover action further includes: switching, by the terminal, a primary TRP and/or a secondary TRP.

Exemplarily, the terminal communicates with at least two TRPs before the cell handover and communicates with at least two TRPs after the cell handover, which is continuously communicating with the TRP of the source cell and the TRP of the target cell. Based on parameters such as transmission distance, transmission rate, or signal strength with each TRP, TRPs may be classified into primary TRP and secondary TRP. After the cell handover, the primary TRP and/or secondary TRP may be switched.

In some embodiments, the terminal switching the primary TRP and/or secondary TRP includes at least one of:
switching the TRP of the source cell from a primary TRP to a secondary TRP; or
switching the TRP of the target cell from a secondary TRP to a primary TRP.

Exemplarily, switching the primary TRP and/or secondary TRP may involve switching the TRP of the source cell from the primary TRP to the secondary TRP; and/or switching the TRP of the target cell from the secondary TRP to the primary TRP.

In the embodiments, during the process of the terminal switching the primary TRP and/or secondary TRP, the terminal never disconnects from any TRP, such that communication between the terminal and a plurality of TRPs is achieved. By switching the TCI state of the dedicated channel of the terminal, the handover delay is reduced, and the communication between the terminal and one or more TRPs is achieved, which improves data transmission efficiency.

In one example, in addition to switching the TCI state, the handover action further includes: handing over, by the terminal, the serving cell to the target cell and applies the configuration of the target cell. Regarding the processes of the embodiments, reference may be made to the corresponding processes in the terminal embodiments, which are not described herein any further.

In one example, the terminal needs to measure and evaluate the configuration of a candidate cell and report the measurement result, such that the network determines the target cell based on the measurement result. FIG. 22 illustrates a flowchart of a method for cell handover according to some exemplary embodiments of the present disclosure. The method further includes the following processes.

In process 2210, a candidate cell configuration and a candidate cell evaluation condition configuration are transmitted.

In process 2220, a measurement result is received from the terminal, wherein the measurement result is obtained by performing a cell measurement based on the candidate cell configuration and performing a measurement evaluation based on the candidate cell evaluation condition, and a target cell for the terminal is determined.

Exemplarily, the network configures at least one candidate cell for the terminal and transmits the candidate cell configuration to the terminal.

In some embodiments, the candidate cell evaluation condition configuration is an L3 measurement configuration and/or L1 measurement configuration.

In the embodiments, the terminal performs the cell measurement and reports the measurement result based on the received information related to the candidate cell configuration. The network receives the measurement result and then determines the target cell of the terminal, which improves the efficiency of determining the target cell.

To further reduce the overhead caused by the terminal in evaluating, measuring, and reporting the measurement result of a candidate cell, FIG. 23 illustrates a flowchart of a method for cell handover according to some exemplary embodiments of the present disclosure. The method further includes the following process.

In process 2310, a candidate cell subset configuration is transmitted, wherein the candidate cell subset configuration is used for instructing the terminal to determine a candidate cell subset for evaluation, measurement, or tracking, wherein the candidate cell subset includes at least one candidate cell from the candidate cell configuration.

Exemplarily, the network may configure a candidate cell subset, and one or more candidate cell subset configurations may be present. The candidate cell subset configuration is used for instructing the terminal to determine a candidate cell subset for evaluation, measurement, or tracking, wherein the candidate cell subset includes at least one candidate cell from the candidate cell configuration.

In some embodiments, FIG. 24 illustrates a flowchart of a method for cell handover according to some exemplary embodiments of the present disclosure. The method further includes the following process.

In process 2410, activation signaling, deactivation signaling, or update signaling of the candidate cell subset is transmitted.

In some embodiments, the activation signaling, deactivation signaling, or update signaling is RRC signaling or L1/L2 signaling. The network transmits the activation signaling, deactivation signaling, or update signaling of the candidate cell subset.

In some embodiments, the candidate cell subset is associated with CSI-RS resource configuration or L1/L2 signaling. The determination and/or measurement of the candidate cell subset is based on L1 and/or L3 measurements.

In some embodiments, FIG. 25 illustrates a flowchart of a method for cell handover according to some exemplary embodiments of the present disclosure. The method further includes the following process.

In process 2510, an association configuration of the candidate cell is transmitted, wherein the association configuration is used for instructing the terminal to associate the SSB and/or the CSI-RS of the candidate cell with the TCI state in the TCI state list of the terminal.

In some embodiments, in one example, FIG. 26 illustrates a flowchart of a method for cell handover according to some exemplary embodiments of the present disclosure. The method further includes the following process.

In process 2610, activation signaling or deactivation signaling of the association configuration is transmitted.

In some embodiments, the network activates/deactivates the association configuration using a MAC CE. The process of transmitting the activation signaling or deactivation signaling is performed simultaneously when, before, or after the network transmits the candidate cell configuration, which is not limited herein and is determined by the network based on actual technical needs.

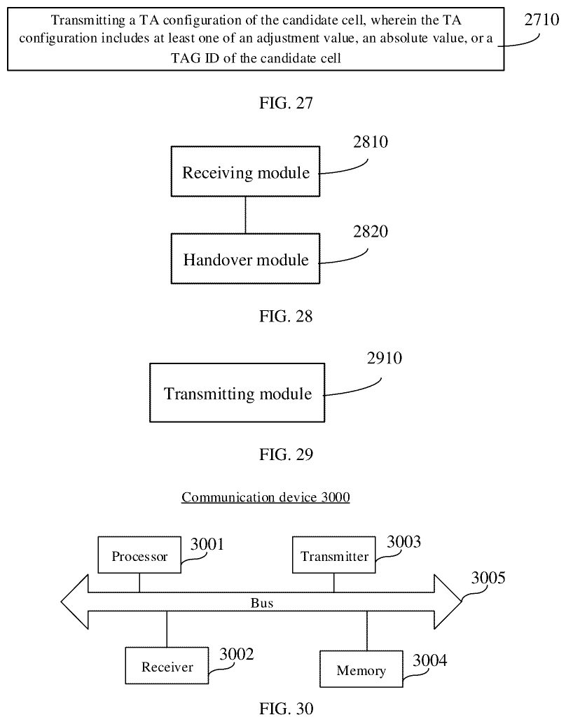

FIG. 27 illustrates a flowchart of a method for cell handover according to some exemplary embodiments of the present disclosure. The method further includes the following process.

In process 2710, a TA configuration of the candidate cell is transmitted, wherein the TA configuration includes at least one of an adjustment value, an absolute value, or a TAG ID of the candidate cell.

According to the above embodiments, the overhead caused by the terminal in evaluating, measuring, and reporting the measurement result of a candidate cell is effectively reduced.

It should be noted that the processes of the network transmitting the candidate cell configuration and the candidate cell evaluation condition configuration, transmitting the candidate cell subset configuration, transmitting the association configuration of the candidate cell, and transmitting the TA configuration of the candidate cell to the terminal are not limited to any specific order. The processes may be performed all at once, partially simultaneously, or in any sequential order, which is not limited herein.

FIG. 28 illustrates a structural block diagram of an apparatus for cell handover according to some exemplary embodiments of the present disclosure. The apparatus includes a receiving module 2810 and a handover module 2820.

The receiving module 2810 is configured to receive first indication information.

The handover module 2820 is configured to perform a handover action based on the first indication information, wherein the handover action includes switching a TCI state.

In some embodiments, the handover module 2820 is configured to perform at least one of:
switching a TCI state of a common channel of the terminal; or
switching a TCI state of a dedicated channel of the terminal.

The dedicated channel includes at least one of a PDCCH, a PDSCH, a PUCCH, or a PUSCH.

In some embodiments, the handover module 2820 is configured to perform at least one of:
stopping receiving the common channel based on a first TCI state, wherein the first TCI state is associated with a source cell; or
receiving the common channel based on a second TCI state, wherein the second TCI state is associated with a target cell and/or other candidate cells.

In some embodiments, the handover module 2820 is configured to perform at least one of:
stopping receiving and/or transmitting the dedicated channel of the terminal based on a first TCI state, wherein the first TCI state is associated with a source cell;
continuing receiving and/or transmitting the dedicated channel of the terminal based on the first TCI state; or
receiving and/or transmitting the dedicated channel of the terminal based on a second TCI state, wherein the second TCI state is associated with a target cell and/or other candidate cells.

In some embodiments, the handover module 2820 is further configured to switch a primary TRP and/or a secondary TRP.

In some embodiments, the handover module 2820 is configured to perform at least one of:
switching a TRP of a source cell from the primary TRP to the secondary TRP; or
switching a TRP of a target cell from the secondary TRP to the primary TRP.

In some embodiments, the handover module 2820 is further configured to hand over a serving cell to the target cell and apply a configuration of the target cell.

In some embodiments, the handover module 2820 is configured to perform at least one of:
applying a TA of the target cell;
monitoring a downlink channel by using a C-RNTI corresponding to the target cell;
initiating a random access procedure to the target cell; or
transmitting uplink data and/or uplink signaling to the target cell by using an uplink grant configured by the target cell.

In some embodiments, the first indication information is used for instructing the terminal to perform an L1/L2 handover.

In some embodiments, the handover module 2820 is configured to: after a PHY or a MAC receives the first indication information, instruct layer 2 to apply the configuration of the target cell, and/or perform a layer 2 operation related to applying the configuration of the target cell.

Alternatively, the handover module 2820 is configured to: after a PHY or a MAC receives the first indication information, indicates information of the target cell to layer 3, to causes the layer 3 to instruct layer 2 to apply a configuration of the target cell, and/or to perform a layer 2 operation related to applying the configuration of the target cell.

The layer 2 includes at least one of a PDCP, an RLC, or a MAC, and the layer 3 includes an RRC.

In some embodiments, the layer 2 operation includes at least one of:
PDCP data recovery;
PDCP re-establishment;
RLC re-establishment; or
MAC reset.

In some embodiments, the receiving module 2810 is further configured to receive a candidate cell configuration and a candidate cell evaluation condition configuration.

In some embodiments, the apparatus further includes: a measuring module.

The measuring module is configured to perform a cell measurement based on the candidate cell configuration and perform a measurement evaluation based on the candidate cell evaluation condition configuration.

In some embodiments, the apparatus further includes: a reporting module.

The reporting module is configured to report a measurement result, wherein the measurement result is used by the network to select a suitable target cell for the terminal.

In some embodiments, the candidate cell configuration includes at least one of:
a special cell configuration, which includes a primary cell configuration and a primary secondary cell configuration;
a secondary cell configuration, which includes a secondary cell configuration;
a cell group configuration, which includes a special cell configuration and a secondary cell configuration; or
a TRP configuration.

In some embodiments, the special cell configuration is associated with at least one candidate cell;
the cell group configuration is associated with at least one candidate cell.

The at least one candidate cell uses at least one of a candidate cell identifier, a serving cell identifier, a physical cell identifier, or a cell global identifier.

In some embodiments, the TRP configuration includes at least one of:
a TCI state list;
a CSI configuration;
a measurement configuration;
a TAG configuration; or
a TRP validity configuration.

In some embodiments, the first indication information carries a target cell identifier indicating that the target cell is at least one of a primary cell, a secondary cell, or a cell within a cell group.

In some embodiments, the first indication information carries TCI state information indicating a TCI state associated with the target cell.

In some embodiments, the receiving module 2810 is configured to receive a candidate cell subset configuration, wherein the candidate cell subset configuration is used for determining a candidate cell subset for evaluation, measurement, or tracking, wherein the candidate cell subset includes at least one candidate cell from the candidate cell configuration.

In some embodiments, the receiving module 2810 is configured to receive activation signaling, deactivation signaling, or update signaling of the candidate cell subset.

In some embodiments, the receiving module 2810 is configured to receive an association configuration of the candidate cell, wherein the association configuration is used for associating an SSB and/or a CSI-RS of the candidate cell with a TCI state in a TCI state list of the terminal.

In some embodiments, the receiving module 2810 is configured to receive activation signaling or deactivation signaling of the association configuration.

In some embodiments, the receiving module 2810 is configured to receive a TA configuration of the candidate cell, wherein the TA configuration includes at least one of an adjustment value, an absolute value, or a TAG ID of the candidate cell.

In some embodiments, the apparatus further includes: a determining module.

The determining module is configured to determine that a handover is successful based on a first condition, or to determine that the handover has failed based on a second condition.

In some embodiments, the first condition includes at least one of the following items:
a random access is successful during the operation of a first timer;
a first downlink message is received without a random access procedure;
the first downlink message is successfully received based on a TCI state indicated by the first indication information; or
a measurement result of a downlink reference signal associated with a TCI state indicated by the first indication information is higher than a threshold.

In some embodiments, the first downlink message includes:
a contention resolution MAC CE;
a TCI state indication;
a TCI state activation/deactivation message;
a new transmission or retransmission scheduled by PDCCH;
a TA command MAC CE;
a serving cell set based SRS TCI state indication MAC CE;
an SP/AP SRS TCI state indication MAC CE;
a BFD-RS indication MAC CE;
a unified TCI states activation/deactivation MAC CE; and
a PUCCH spatial relation activation/deactivation for multiple TRP PUCCH repetition MAC CE.

In some embodiments, the second condition includes at least one of the following items:
a random access has failed;
layer 1 indicates failure information;
a first timer has expired;
the maximum number of transmissions for a first uplink message has been reached; or
a new transmission schedule was not received prior to expiration of a second timer.

In some embodiments, in the case of a handover failure, the handover module 2820 is configured to perform at least one of:
indicating a handover failure or a random access problem to layer 2 or layer 3;
triggering an RRC connection re-establishment;
selecting a target cell that meets the reselection condition among candidate cells to trigger the handover again;
transmitting a handover failure indication to the source cell; or
releasing a candidate cell configuration.

In some embodiments, the apparatus further includes: a releasing module.

The releasing module is configured to release a first resource based on first indication information.

In some embodiments, the releasing module is configured to perform at least one of:
notifying RRC to release PUCCH resources for all serving cells in the case that a PUCCH resource is configured;
notifying RRC to release SRS resources for all serving cells in the case that an SRS resource is configured;
clearing all configured downlink assignments and configured uplink grants; or
clearing all PUCCH resources for semi-persistent CSI reporting.

FIG. 29 illustrates a structural block diagram of an apparatus for cell handover according to some exemplary embodiments of the present disclosure. The apparatus includes a transmitting module 2910.

The transmitting module 2910 is configured to transmit first indication information.

The first indication information is used for instructing the terminal to perform a handover action, wherein the handover action includes switching a TCI state.

In some embodiments, switching the TCI state includes at least one of:
switching a TCI state of a common channel of the terminal; or
switching a TCI state of a dedicated channel of the terminal.

The dedicated channel includes at least one of a PDCCH, a PDSCH, a PUCCH, or a PUSCH.

In some embodiments, switching the TCI state of the common channel of the terminal includes at least one of:
stopping receiving the common channel based on a first TCI state, wherein the first TCI state is associated with a source cell; or
receiving the common channel based on a second TCI state, wherein the second TCI state is associated with a target cell and/or other candidate cells.

In some embodiments, switching the TCI state of the dedicated channel of the terminal includes at least one of:
stopping receiving and/or transmitting the dedicated channel of the terminal based on a first TCI state, wherein the first TCI state is associated with a source cell;
continuing receiving and/or transmitting the dedicated channel of the terminal based on a first TCI state; or
receiving and/or transmitting the dedicated channel of the terminal based on a second TCI state, wherein the second TCI state is associated with a target cell and/or other candidate cells.

In some embodiments, the handover action further includes: switching, by the terminal, the primary TRP and/or the secondary TRP.

In some embodiments, switching the primary TRP and/or the secondary TRP includes at least one of: switching a TRP of a source cell from the primary TRP to the secondary TRP; or switching a TRP of a target cell from the secondary TRP to the primary TRP.

In some embodiments, the handover action further includes: handing over a serving cell to the target cell and applies a configuration of the target cell.

In some embodiments, the transmitting module 2910 is configured to transmit a candidate cell configuration and a candidate cell evaluation condition configuration.

In some embodiments, the apparatus further includes: a receiving module.

The receiving module is configured to receive a measurement result from the terminal, which is obtained by performing a cell measurement based on the candidate cell configuration and performing a measurement evaluation based on the candidate cell evaluation condition.

In some embodiments, the apparatus further includes: a determining module.

The determining module is configured to determine a target cell for the terminal based on the measurement result.

In some embodiments, the transmitting module 2910 is configured to transmit a candidate cell subset configuration, wherein the candidate cell subset configuration is used for instructing the terminal to determine a candidate cell subset for evaluation, measurement, or tracking, wherein the candidate cell subset includes at least one candidate cell from the candidate cell configuration.

In some embodiments, the transmitting module 2910 is configured to transmit activation signaling, deactivation signaling, or update signaling of the candidate cell subset.

In some embodiments, the transmitting module 2910 is configured to transmit an association configuration of the candidate cell, wherein the association configuration is used for instructing the terminal to associate an SSB and/or a CSI-RS of the candidate cell with a TCI state in a TCI state list of the terminal.

In some embodiments, the transmitting module 2910 is configured to transmit activation signaling or deactivation signaling of the association configuration.

In some embodiments, the transmitting module 2910 is configured to transmit a TA configuration of the candidate cell, wherein the TA configuration includes at least one of an adjustment value, an absolute value, or a TAG ID of the candidate cell.

FIG. 30 illustrates a schematic structural diagram of a communication device (a terminal or a network device) according to some exemplary embodiments of the present disclosure. The communication device 3000 includes: a processor 3001, a receiver 3002, a transmitter 3003, a memory 3004, and a bus 3005.

The processor 3001 includes one or more processing core. The processor 3001 runs various functional applications and perform information processing by running software programs and modules.

The receiver 3002 and the transmitter 3003 may be implemented as a communication assembly, which may be a communication chip.

The memory 3004 is connected to the processor 3001 via the bus 3005. The memory 3004 is configured to store at least one executable instruction, and the processor 3001 is configured to execute the at least one executable instruction, to cause the communication device 3000 to perform the processes in the above method embodiments.

In addition, the memory 3004 may be practiced by any type of volatile or non-volatile storage device, or a combination of both. The volatile or non-volatile storage device includes, but is not limited to: a magnetic or optical disk, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

Those skilled in the art should understand that the structure illustrated in FIG. 30 does not constitute limitations on the communication device 3000, and the communication device may include more or fewer components than those illustrated, or some of the components may be combined, or a different arrangement of components may be employed.

In some exemplary embodiments, the present disclosure provides a communication chip. The communication chip includes one or more programmable logic circuits and/or one or more program instructions. The communication chip, when running on a terminal or a network device, is caused to perform the method for cell handover.

The present disclosure provides a computer-readable storage medium. The computer-readable storage medium stores at least one instruction, at least one program segment, a code set, or an instruction set. The at least one instruction, the at least one program segment, the code set, or the instruction set, when loaded and executed by a processor, causes the processor to perform the method for cell handover according to the above method embodiments.

The present disclosure provides a computer program product or a computer program. The computer program product or the computer program includes one or more computer instructions. The one or more computer instructions are stored in a computer-readable storage medium. The one or more computer instructions, when read from the computer-readable storage medium and executed by a processor of a computer device, causes the computer device to perform the method for cell handover according to the above method embodiments.

The serial numbers of the embodiments of the present disclosure are merely for description, and do not represent the advantages and disadvantages of the embodiments.

It should be understood by those of ordinary skill in the art that all or a part of the processes for implementing the above embodiments are completed by hardware, or are completed by instructing relevant hardware by a program stored in a computer-readable storage medium. The storage medium mentioned above is a read-only memory, a magnetic disk, a compact disk, or the like.

Those skilled in the art should appreciate that in one or more of the above embodiments, the functions described in the embodiments of the present disclosure may be practiced by hardware, software, firmware, or any combination thereof. In the case that the functions are practiced by the software, the functions are stored in a computer-readable medium or transmitted as one or more instructions or codes on the computer-readable medium. The computer-readable medium includes a computer-readable storage medium and a communication medium. The communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for cell handover, applicable to a terminal, the method comprising:
receiving first indication information; and
performing a handover action based on the first indication information, wherein the handover action comprises switching a transmission configuration indication (TCI) state.

2. The method according to claim 1, wherein switching the TCI state comprises at least one of:
switching a TCI state of a common channel of the terminal; or
switching a TCI state of a dedicated channel of the terminal;
wherein the dedicated channel comprises at least one of a physical downlink control channel (PDCCH), a physical downlink shared channel (PDSCH), a physical uplink control channel (PUCCH), or a physical uplink shared channel (PUSCH).

3. The method according to claim 2, wherein
switching the TCI state of the common channel of the terminal comprises at least one of: stopping receiving the common channel based on a first TCI state, wherein the first TCI state is associated with a source cell; or receiving the common channel based on a second TCI state, wherein the second TCI state is associated with a target cell and/or other candidate cells; or
switching the TCI state of the dedicated channel of the terminal comprises at least one of: stopping receiving and/or transmitting the dedicated channel of the terminal based on a first TCI state, wherein the first TCI state is associated with a source cell; continuing receiving and/or transmitting the dedicated channel of the terminal based on a first TCI state; or receiving and/or transmitting the dedicated channel of the terminal based on a second TCI state, wherein the second TCI state is associated with a target cell and/or other candidate cells.

4. The method according to claim 1, wherein the handover action further comprises:
switching a primary transmission reception point (TRP) and/or a secondary TRP;
wherein switching the primary TRP and/or the secondary TRP comprises at least one of:
switching a TRP of a source cell from the primary TRP to the secondary TRP; or
switching a TRP of a target cell from the secondary TRP to the primary TRP.

5. The method according to claim 1, wherein the handover action further comprises:
handing over a serving cell to the target cell and applying a configuration of the target cell; or
wherein the first indication information is used for instructing the terminal to perform a layer 1/layer 2 (L1/L2) handover.

6. The method according to claim 5, wherein applying the configuration of the target cell comprises at least one of:
applying a timing advance (TA) of the target cell;
monitoring a downlink channel by using a cell-radio network temporary identifier (C-RNTI) corresponding to the target cell;
initiating a random access procedure to the target cell;
transmitting uplink data and/or uplink signaling to the target cell by using an uplink grant configured by the target cell;
after a physical (PHY) layer or a medium access control (MAC) layer receives the first indication information, instructing a layer 2 to apply the configuration of the target cell, and/or performing a layer 2 operation related to applying the configuration of the target cell; or
after a PHY or a MAC receives the first indication information, indicating information of the target cell to a layer 3, to cause the layer 3 to instruct a layer 2 to apply the configuration of the target cell, and/or performing a layer 2 operation related to applying the configuration of the target cell,
wherein the layer 2 comprises at least one of a Packet Data Convergence Protocol (PDCP) layer, a radio-link control (RLC) layer, or a MAC, and the layer 3 comprises a radio resource control (RRC) layer; and
wherein the layer 2 operation comprises at least one of:
PDCP data recovery;
PDCP re-establishment;
RLC re-establishment; or
MAC reset.

7. The method according to claim 1, further comprising:
receiving a candidate cell configuration and a candidate cell evaluation condition configuration;
performing a cell measurement based on the candidate cell configuration; and
performing a measurement evaluation based on the candidate cell evaluation condition configuration and reporting a measurement result, wherein the measurement result is used by a network to select a suitable target cell for the terminal;
wherein the candidate cell configuration comprises at least one of:
a special cell configuration, wherein the special cell configuration comprises a primary cell configuration and a primary secondary cell configuration;
a secondary cell configuration;
a cell group configuration, wherein the cell group configuration comprising a special cell configuration and a secondary cell configuration; or
a transmission reception point (TRP) configuration.

8. The method according to claim 7, wherein
the special cell configuration is associated with at least one candidate cell;
the secondary cell configuration is associated with at least one candidate cell; and
the cell group configuration is associated with at least one candidate cell,
wherein the at least one candidate cell uses at least one of a candidate cell identifier, a serving cell identifier, a physical cell identifier, or a cell global identifier;
wherein the TRP configuration comprises at least one of:
a TCI state list;
a channel state information (CSI) configuration;
a measurement configuration;
a timing advance (TA) group (TAG) configuration; or
a TRP validity configuration.

9. The method according to claim 7, wherein the first indication information carries a target cell identifier indicating that the target cell is at least one of a primary cell, a secondary cell, or a cell within a cell group; and
wherein the first indication information carries TCI state information indicating a TCI state associated with the target cell.

10. A terminal, comprising:
a processor;
a transceiver, communicably connected to the processor; and
a memory, configured to store one or more executable instructions;
wherein the processor is configured to load and execute the one or more executable instructions, to cause the terminal to perform:
receiving first indication information; and
performing a handover action based on the first indication information, wherein the handover action comprises switching a transmission configuration indication (TCI) state.

11. The terminal according to claim 10, wherein the processor is configured to load and execute the one or more executable instructions, to cause the terminal to further perform:
receiving a candidate cell configuration and a candidate cell evaluation condition configuration;
performing a cell measurement based on the candidate cell configuration; and
performing a measurement evaluation based on the candidate cell evaluation condition configuration and reporting a measurement result, wherein the measurement result is used by a network to select a suitable target cell for the terminal.

12. The terminal according to claim 11, wherein the processor is configured to load and execute the one or more executable instructions, to cause the terminal to further perform at least one of:
receiving a candidate cell subset configuration, wherein the candidate cell subset configuration is used for determining a candidate cell subset for evaluation, measurement, or tracking, wherein the candidate cell subset comprises at least one candidate cell from the candidate cell configuration; or
receiving activation signaling, deactivation signaling, or update signaling of the candidate cell subset.

13. The terminal according to claim 10, wherein the processor is configured to load and execute the one or more executable instructions, to cause the terminal to further perform:
determining that a handover is successful based on a first condition; or
determining that a handover has failed based on a second condition;
wherein the first condition comprises at least one of the following items:
a random access is successful during an operation of a first timer;
a first downlink message is received without a random access procedure;
a first downlink message is successfully received based on a TCI state indicated by the first indication information; or
a measurement result of a downlink reference signal associated with a TCI state indicated by the first indication information is higher than a threshold value;
wherein the second condition comprises at least one of the following items:
a random access has failed;
a layer 1 indicates failure information;
a first timer has expired;
a maximum number of transmissions for a first uplink message has been reached; or
a new transmission schedule was not received prior to expiration of a second timer.

14. The terminal according to claim 13, wherein the first downlink message comprises:
a contention resolution medium access control (MAC) control element (CE);
a TCI state indication;
a TCI state activation/deactivation message;
a new transmission or retransmission scheduled by a physical downlink control channel (PDCCH);
a timing advance (TA) command MAC CE;
a serving cell set based sounding reference signal (SRS) TCI state indication MAC CE;
a service provider/application provider (SP/AP) SRS TCI state indication MAC CE;
a determined beam failure detection reference signal (BFD-RS) indication MAC CE;
a unified TCI states activation/deactivation MAC CE; and
a physical uplink control channel (PUCCH) spatial relation activation/deactivation for multiple transmission reception point (TRP) PUCCH repetition MAC CE.

15. The terminal according to claim 13, wherein in a case of a handover failure, the processor is configured to load and execute the one or more executable instructions, to cause the terminal to further perform at least one of:
indicating the handover failure or a random access problem to a layer 2 or a layer 3;
triggering an RRC connection re-establishment;
selecting a target cell that meets a reselection condition among candidate cells to trigger a handover again;
transmitting a handover failure indication to a source cell; or
releasing a candidate cell configuration.

16. A network device, comprising:
a processor;
a transceiver, communicably connected to the processor; and
a memory, configured to store one or more executable instructions;
wherein the processor is configured to load and execute the one or more executable instructions, to cause the network device to perform:
transmitting first indication information;
wherein the first indication information is used for instructing a terminal to perform a handover action, wherein the handover action comprises switching a transmission configuration indication (TCI) state.

17. The network device according to claim 16, wherein the processor is configured to load and execute the one or more executable instructions, to cause the network device to further perform:
transmitting a candidate cell configuration and a candidate cell evaluation condition configuration; and
receiving a measurement result from the terminal, wherein the measurement result is obtained by performing a cell measurement based on the candidate cell configuration and performing a measurement evaluation based on the candidate cell evaluation condition configuration, and determining a target cell for the terminal.

18. The network device according to claim 16, wherein the processor is configured to load and execute the one or more executable instructions, to cause the network device to further perform:
transmitting an association configuration of the candidate cell, wherein the association configuration is used for instructing the terminal to associate a synchronization signal and physical broadcast channel (PBCH) block (SSB) and/or a channel state information-reference signal (CSI-RS) of the candidate cell with a TCI state in a TCI state list of the terminal.

19. The network device according to claim 18, wherein the processor is configured to load and execute the one or more executable instructions, to cause the network device to further perform:
transmitting activation signaling or deactivation signaling of the association configuration.

20. The network device according to claim 17, wherein the processor is configured to load and execute the one or more executable instructions, to cause the network device to further perform:
transmitting a timing advance (TA) configuration of the candidate cell, wherein the TA configuration comprises at least one of an adjustment value, an absolute value, or a TA group (TAG) identifier (ID) of the candidate cell.
